(19) United States
(12) Patent Application Publication
(10) Pub. No.: US 2023/0015846 A1
(43) Pub. Date: Jan. 19, 2023

(54) SYSTEMS AND METHODS FOR AUTOMATED DIGITIZATION OF AND WORKFLOWS FOR DATA OBJECT MODEL

(71) Applicant: LiquidX, Inc., New York, NY (US)

(72) Inventors: James Toffey, New York, NY (US); Frank Dimarco, New York, NY (US); Albert Hofeldt, New York, NY (US); Kristen Michaud, New York, NY (US); Andrew Chu, New York, NY (US); John Filippone, New York, NY (US)

(21) Appl. No.: 17/949,040

(22) Filed: Sep. 20, 2022

Related U.S. Application Data
(63) Continuation of application No. PCT/US2021/031754, filed on May 11, 2021.
(60) Provisional application No. 63/022,686, filed on May 11, 2020.

(51) Int. Cl. G06Q 40/04; G06Q 40/06; G06Q 10/10; G06N 20/00

(52) U.S. Cl. CPC G06Q 40/04; G06Q 40/06; G06Q 10/10; G06N 20/00

(57) ABSTRACT

Methods and systems include a trade finance digital asset platform that generally provides improved visibility, security, and workflow execution for a set of trade finance transactions enabling capabilities for trade finance asset digitization, a trade finance data object model, interfaces to systems used by parties to trade finance transactions, event and state reporting services, and smart contract services that optionally operate using a blockchain.

### CROSS-REFERENCE TO RELATED APPLICATIONS

This application claims priority to U.S. provisional application No. 63/022,686, filed on May 11, 2020, and PCT Application PCT/US21/31754 filed on May 11, 2021, each of which is hereby incorporated by reference as if fully set forth herein in its entirety.

### TECHNICAL FIELD

The present disclosure relates to a system for digitization and trading of trade finance assets and to a trade finance digital platform that provides unified views of trade related workflow and transaction information to all the entities in a trade finance or supply chain network.

### BACKGROUND

Trade transactions can involve the sale of goods or services from a seller to a buyer. Intermediaries such as banks, financial institutions, and insurance providers can facilitate such transactions by providing financing, such as to cover various costs during time periods in which payments are pending, and by underwriting the risks involved in the trade transactions. This is generally referred to as “trade finance,” which as used herein, except where context indicates otherwise, is intended to encompass all such activities that are involved in financing or underwriting trade transactions and trade-related supply chain activities including financing of accounts receivable, working capital loans, asset-backed loans, asset sales, and other financing structures, as well as trade credit insurance and other activities or workflows that involve trade and working capital assets. The network in which these various trade finance and other trade and trade-related supply chain activities take place is referred to herein for convenience as a “trade finance network.”

Traditional trade finance is largely paper-based and is conducted through one or more instruments such as invoices, purchase orders, bank guarantees, letters of credit, insurance certificates, bills of lading, logistics documents and customs documents, and the like. These instruments are used by the financial and other intermediaries to provide financial resources and/or assumption of financial risk to one or more parties involved in a trade workflow. Although other durations are possible, trade finance instruments usually have short term maturities of roughly 30, 60, or 90 days reflecting typical shipping or delivery times of goods traded, but longer maturities are possible such as 180 days, 360 days, one year or longer, or variations thereof.

One of the most common and standardized instruments used in trade finance to facilitate trade transactions is a letter of credit. A letter of credit is a financial document from a creditor, such as a bank, on the buyer's behalf that assures payment to the seller. In case a buyer is unable to make payment to the seller, the letter of credit allows the seller to demand payment from the bank. Thus, the bank acts as an intermediary between the buyer and the seller, effectively substituting the bank's credit for the buyer's credit.

Trade finance documents, such as the letters of credit issued by banks, are typically largely paper-based. To the extent trade finance documents are digitized, they are still typically turned into document files (e.g., pdf documents and spreadsheets) that replicate paper forms and are sent from party-to-party by electronic mail or fax systems. Whether purely paper-based or embodied in document files, trade finance documents typically lack any ability to provide real time status information regarding aspects of a trade transaction to buyers, sellers, creditors, insurers and other parties, and obtaining accurate, up-to-date information about a given transaction or set of transactions typically requires reading and reconciliation of various electronic mail chains and attached spreadsheets and documents. This means that trade credit often remains pending and on the books for weeks or longer after buyers and sellers have completed all of the activities needed to complete a transaction, including delivery of goods and payment. Thus, Applicant appreciates the use of inefficient, disconnected, systems in traditional trade finance means that the different participants of the trade finance network, including sellers, buyers, banks and other financial institutions, insurance providers, and logistics providers all work in data silos isolated from one another with no visibility of the trade flow. In turn, Applicant appreciates that this results in inefficient use of otherwise available working capital, higher cost of available working capital and limited liquidity in the trade finance network. Applicant appreciates that a need exists for improved methods and systems for providing better visibility about trade finance transactions for all parties involved, more convenient and standardized transactions, faster reconciliation of transactions, and more effective overall use of available working capital.

### SUMMARY

Provided herein are improved methods and systems that provide comprehensive, real-time visibility about trade finance transactions for all parties involved, more convenient and standardized transactions, faster reconciliation of transactions, and more effective overall use of available working capital for trade finance activities. Among other things, these include various methods, systems, components, processes, modules, blocks, circuits, sub-systems, articles, and other elements (collectively referred to in some cases as the “platform” or the “system,” which terms should be understood to encompass any of the above except where context indicates otherwise) that individually or collectively enable advances in trade finance activities disclosed herein.

In embodiments, an optionally blockchain-based trade finance digital platform with a user interface provides unified views of the trade related workflow and transaction information to all the entities of a trade finance network. In embodiments, the trade finance digital platform provides for automation of workflows in a trade finance network using smart contracts that embody trade finance legal terms and conditions and that automate execution of a set of legal terms and conditions by operating on data that is available in a trade finance activity, optionally recording transaction information on a distributed ledger, such as in a blockchain.

In embodiments, the trade finance digital platform provides for digitization of trade finance assets or entities (such as legal documents, letters of credit, documents or communications relating to trade receivables, and the like) according to a standardized framework (such as a set of document models that are configured to align with a set of smart contract models), thereby enabling digital interactions with such objects among the various parties of a trade finance network. In addition to legal and financial conditions, there are business criteria (such as supply chain logistics criteria and/or criteria of successful completion of assets) and requirements that may be required and satisfied between business relationships for transactions to be considered “accepted” in conjunction with legal terms and conditions. The combination of business and legal terms and conditions, which are agreeable to the parties, can be governed by smart contracts. By way of these examples, the smart contract can operate within the system in a “machine-to-machine” fashion such that the smart contracts can be in the form of codified business logic.

In embodiments, a set of digitized assets or entities can travel as reference data serving as the “digital payload” that is a “static digital representation” of the asset or entity. In embodiments, assets or entities are bundled with the representative data model specific to the asset class as well as the terms and conditions (both legal and business). The dissection, content definition, relevance mapping, and data mapping can, therefore, transform a classic digital asset into a framework-standardized, transactable digital asset, referred to in certain examples as an “InBlocked” digital asset. The framework-standardized, transactable digital asset coupled with the legal and business terms all combine into an encapsulated intelligent digital package ready for transaction. Depending on the workflow, the asset, procurement history and the like, there can be additional asset metadata that adds to the relevance and validity of the asset. This type of history and additional metadata may vary by asset class, level of system integration and sophistication of customers. In embodiments, the digital trade assets or entities include digital trade finance assets, digital trade credit insurance assets, digital working capital loan assets, digital commercial loan assets and so on.

In embodiments, a blockchain may be a private, permissioned blockchain controlled by a single entity or a consortium of trusted entities, that is built using a pre-configured application programming interface (API), such as one provided on a commercially available blockchain, such as CORDA™, Hyperledger™, Quorum™, or public blockchain networks, such as Ethereum™, as well as chaincode languages such as Golang, Javascript, Java, Kotlin, or DAML, and the like. In embodiments, the blockchain uses a consensus algorithm, such as a proof-of-stake algorithm, or the like.

In embodiments, a trade finance digital platform includes a trade finance asset digitization and tracking system for helping a user create a trade finance asset from a set of data records containing receivables information, legal information (such as terms and conditions for a transaction) and supply chain information related to a set of trade finance agreements; a trade finance asset workflow and trading system with a user interface for providing a set of unified views for a set of asset workflow and trading applications for trade finance assets; data collection and management for collecting and organizing data collected from the trade finance network including data from the events, transactions and entities in the trade finance network; a data storage system for storing data collected about events, transactions and entities in the trade finance network; and a data processing and artificial intelligence system for processing data about events, transactions and entities and facilitating development and deployment of automation, machine learning, artificial intelligence, and/or analytics for a wide variety of trade finance network applications.

The trade finance digital platform may, in embodiments, enable a wide range of new or improved user experiences, activities and workflows in accordance with the benefits noted above. In embodiments, the trade finance digital platform includes a set of dashboard interfaces for configuring a set of smart contracts for automating workflows in a trade finance network. In embodiments, the trade finance digital platform implements a smart contract for validating the authenticity of a sale of goods related to the invoice. In embodiments, the trade finance digital platform implements a smart contract for initiating shipment of goods from the seller to the buyer upon receiving digitally signed letter of credit. In embodiments, the trade finance digital platform implements a smart contract for processing partial payment upon occurrence of a supply chain event corresponding to the physical movement of goods along the supply chain. In embodiments, the trade finance digital platform implements a smart contract for processing partial payment upon delivery of goods to the buyer in accordance with the terms and conditions of the trade transaction.

In embodiments, the trade finance digital platform implements a smart contract for automatically processing an insurance claim upon non-payment of the invoice. In embodiments, the trade finance digital platform implements a smart contract for automatically providing insurance reporting and monitoring, such as of potentially relevant trade, supply chain or financial activities or events occurring during the coverage period of a trade credit insurance policy. In embodiments, the autonomous nature of the network ecosystem is enabled by the combination of the application logic of the digital asset framework described herein in conjunction with blockchain-based smart contracts. By way of these examples, the application logic of the digital asset framework and the distributed ledger technology can combine to enable successful digitization, validation, insurance and transaction processing, among other benefits.

In embodiments, the trade finance digital platform includes an authentication service configured to authenticate the identity of users of trade finance digital platform. In embodiments, the trade finance digital platform includes an entitlement service to define the roles and access privileges of users of trade finance digital platform. In embodiments, the trade finance digital platform includes a reporting service configured to report the status of trade finance network to the various entities of the trade finance network. In embodiments, the trade finance digital platform includes an instant messaging service configured to enable the entities in the trade finance network to communicate with each other in real time. In embodiments, the trade finance digital platform includes a compliance service configured to perform know-your-customer (KYC) and anti-money laundering (AML) compliance checks on users of the trade finance digital platform. In embodiments, the trade finance digital platform includes an integration service configured to provide integration of the trade finance digital platform with a third-party information technology system, such as an enterprise system of a buyer or a seller, or a system of a bank, insurance provider (including, but not limited to, an insurance company and/or insurance broker), service provider, freight forwarder, shipper, or other party involved in a trade finance transaction.

In embodiments, a trade finance asset digitization and tracking system includes a data digitization engine with a data extraction module for extracting data from physical documents and digital documents in multiple formats and a data processing module for normalizing and transforming data to create a trade finance data object that represents a trade finance entity or asset; a set of business rules to transform raw data records into data model-consistent data objects; a blockchain for recording data, such as events, actions, states and the like; and a set of services.

In embodiments, a trade finance asset workflow and trading system includes an orchestration engine for orchestrating the creation and management of business rules, logic and policies related to registration and onboarding of an entity onto the trade finance digital platform, credit and risk management, payments, insurance and compliance; a set of business rules; a workflow manager for managing a set of workflows related to various events, activities and transactions in the trade finance network; and a set of services performed by trade finance asset workflow and trading system.

In embodiments, the trade finance asset workflow and trading system includes an order management service to facilitate and manage a buy or sell order for a trade finance digital asset. In embodiments, the trade finance asset workflow and trading system includes a matching service to match sell orders or asks for a digital asset with a buy order or bid for executing a trade. In embodiments, the trade finance asset workflow and trading system includes an alert service to provide real time alerts and notifications to buyers and/or sellers upon finding a match. In embodiments, the trade finance asset workflow and trading system includes an auctioning service to offer a digital asset to a set of buyers on the platform. In embodiments, the trade finance asset workflow and trading system may include other protocols for initiating or completing transactions, such as private placement protocols, requests-for-quotes (RFQs), syndication protocols, and the like. In embodiments, the trade finance asset workflow and trading system includes an analytics service to provide data analytics around capital management, credit management, risk management, asset pricing, and the like.

In embodiments, a trade finance digital platform provides a marketplace for the trading and financing of standardized digital assets by financiers and investors. This may include a primary marketplace and optionally a secondary market (in some cases referred to as a distribution market) where assets may, for example, be aggregated, grouped, or the like.

In embodiments, the trade finance digital platform provides a marketplace for the trading and financing of loans. In embodiments, the trade finance digital platform provides a marketplace for the trading and financing of securitized trade finance loans. In embodiments, the trade finance digital platform provides a marketplace for the trading and financing of accounts receivable and payables. In embodiments, the trade finance digital platform provides a marketplace for the trading and financing of a trade credit insurance policy or a set of trade credit insurance policies, and/or for the distribution of trade credit insurance coverage across multiple insurers, which may include primary insurers, and secondary insurers, such as reinsurers. In embodiments, the marketplace is a primary marketplace where buyers, sellers and financiers engage in trade financing, factoring and reverse factoring. In embodiments, the marketplace is a secondary marketplace where digital assets are available for trading by institutional investors.

In embodiments, a trade finance digital platform provides a distributed application (dapp) marketplace for enabling the entities of trade finance network to create and publish apps on the trade finance network.

In embodiments, a trade finance digital platform for generating a digital trade asset includes denoting a value of a trade transaction between a seller and a buyer; storing the digital trade asset on the blockchain to provide unified view to buyer, seller and other entities of the trade finance network; tracking movement of goods and/or documents through the supply chain and in response to certain supply chain events recording such events on the blockchain; and processing partial or full payment for the trade transaction.

In embodiments, the trade finance digital platform validates a supply chain event when one or more entities approve the event through their private key. In embodiments, the trade finance digital platform tracks supply chain events by including a timestamp capturing the time of occurrence of the event.

In embodiments, a method of creating a digital trade asset like a trade finance asset includes receiving a corpus of trade documents across multiple domains and sources; parsing the trade documents to identify and extract relevant data elements; transforming relevant data elements to fit a data model for a set of digital trade assets; and loading the data model onto the trade finance digital platform to create a digital trade asset, which may be linked to smart contracts that embody and may automatically execute asset-relevant legal terms.

In embodiments, a trade finance digital platform provides robotic automation of roles in trade finance activities. In embodiments, the trade finance digital platform includes a robotic process automation (RPA) bot for capturing, extracting and classifying key information from a set of trade finance documents. In embodiments, the trade finance digital platform includes a robotic process automation (RPA) bot for managing the automation of reconciliation of data records at one or more entities of the trade finance network. In embodiments, the trade finance digital platform includes a robotic process automation (RPA) bot for managing the automation of compliance requirements of one or more entities of the trade finance network. In embodiments, the trade finance digital platform includes a robotic process automation (RPA) bot for managing the automation of back office operations at one or more entities of the trade finance network. In embodiments, the trade finance digital platform includes a robotic process automation (RPA) bot for managing the automation of accounts payable process at a bank for accounts payable related to trade finance transactions. In embodiments, the trade finance digital platform includes a robotic process automation (RPA) bot for managing the automation of accounts receivable process at a bank for accounts receivable involved in a trade finance transaction. In embodiments, the trade finance digital platform includes a robotic process automation (RPA) bot for managing the automation of trade credit insurance policy administration and servicing process at the insurance provider. In embodiments, the trade finance digital platform includes a robotic process automation (RPA) bot for managing and/or administering trade credit insurance policies within a financing entity, such as a bank. In embodiments, the trade finance digital platform includes a robotic process automation (RPA) bot for managing the automation of trade credit insurance policy underwriting and pricing at the insurance provider. In embodiments, the trade finance digital platform includes a robotic process automation (RPA) bot for comparing the terms of different legal trade finance contracts or trade credit insurance policies involved in a set of trade finance transactions. Examples of robotic process automation (RPA) technology that can be used in accordance with the present disclosure include, but are not limited to, UiPath, Blue Prism, Taskt, and Robotic Framework.

In embodiments, a trade finance digital platform includes a system for learning on a training set of outcomes, parameters, and data collected from data sources related to digital trade assets in a trade finance network to train an artificial intelligence/machine learning system to generate pricing for the digital trade finance assets.

In embodiments, a trade finance digital platform includes a system for learning on a training set of outcomes, parameters, and data collected from data sources related to digital trade assets in a trade finance network to train an artificial intelligence/machine learning system to determine a risk score related to a digital trade finance asset or workflow, such as a credit risk score, a compliance risk score, an AML, risk score, or the like.

In embodiments, a trade finance digital platform includes a system for learning on a training set of outcomes, parameters, and data collected from data sources related to digital trade finance assets in a trade finance network to train an artificial intelligence/machine learning system to identify transactions with compliance concerns.

In embodiments, a trade finance digital platform includes a system for utilizing data collected from data sources related to digital trade finance assets in a trade finance network to onboard network participants.

In embodiments, a trade finance digital platform includes a system for learning on a training set of outcomes, parameters, and data collected from data sources related to digital trade assets in a trade finance network to train an artificial intelligence/machine learning system to predict timeliness and extent of payment on trade finance receivables and/or payables.

In embodiments, the user experience workflows of the trade finance digital platform may allow the various entities in the trade finance network to, among other things: digitize trade documents to create a class of digital trade assets in a trade finance network and provide real time visibility of such assets for all the entities of the trade finance network; securitize and tokenize such digital trade assets to provide liquidity for such assets; enable real time settlement of trade transactions; enable all the entities of a trade finance network to track the movement of goods from a seller to a buyer through a supply chain network; view the status of a trade transaction between a seller and a buyer of a good and provide services based on the status; forecast cash flow based on the status of one or more trade transactions with one or more counterparties; automatically track and report on state information for a digital trade asset; automatically handle the timeliness of workflows for the digital trade finance asset; automatically handle the trade finance transaction including creation of a digital trade asset, processing of payment for the transaction, settlement and reconciliation of the trade transaction; perform reconciliation associated with procure-to-cash and procure-to-pay business processes; and automatically handle the legal and/or compliance framework around a class of digital trade asset, such as for compliance with law, regulation or corporate policy.

In embodiments, a trade finance digital platform includes a distributed data architecture for storing data relating to a set of entities in a trade finance network, where the entities are managed by a trade finance digital platform.

In embodiments, a trade finance digital platform includes a multi-tenant data architecture for storing data relating to a set of entities in a trade finance network in a data storage facility, where the entities are managed by a value chain network management platform and wherein interactions with the data storage facility are managed based on a set of tenant-specific policies.

In embodiments, provided herein are methods and systems for a trade finance digital asset platform, which may include a set of services for ingesting a set of trade finance documents relating to a set of trade finance transactions and transforming components thereof to form a set of trade finance digital objects that align with a trade finance data object model; a set of input interfaces for taking a set of input data from a set of information technology systems that handle information related to the set of trade finance transactions, including input data that indicates the status of at least one of delivery data for goods, tracking data for performance of services, acceptance data for goods, and payment status data; a set of blockchain services for storing a set of events and a set of states of the trade finance digital objects, including events and states included in the set of input data; a set of smart contracts embodying terms and conditions applicable to the set of trade finance transactions and providing automated processing of the set of input data, the set of events and the set of states, wherein the set of smart contracts automatically updates the set of blockchain services and automatically notifies a party of at least one of an event and a state change related to a trade finance transaction; and a set of reporting services for reporting on a set of events and states in the platform to parties to the trade finance transactions.

In embodiments, a trade finance digital asset platform includes a set of services for ingesting, interpreting, transforming and mapping a set of trade finance documents relating to a set of trade finance transactions and transforming components thereof to form a set of trade finance digital objects that align with a trade finance data object model. The platform includes a set of input interfaces for taking a set of input data from a set of information technology systems that handle information related to the set of trade finance transactions including input data that indicates the status of at least one of delivery data for goods, acceptance data for goods, and payment status data. The platform includes a set of blockchain services for storing a set of events and a set of states of the trade finance digital objects including events and states included in the set of input data and a set of smart contracts embodying terms and conditions applicable to the set of trade finance transactions and providing automated processing of the set of input data, the set of events and the set of states. The set of smart contracts automatically updates the set of blockchain services and automatically notifies a party of at least one of an event and a state change related to a trade finance transaction. The platform also includes a set of reporting services for reporting on a set of events and states in the platform to parties to the trade finance transactions.

In embodiments, a computer-implemented method for generating a set of trade finance digital objects, as well as a computing system for performing the method, is disclosed. The method can include acquiring, by a computing device having one or more processors, a set of trade finance documents. Each of the trade finance documents can comprise a record of a financial arrangement between a first party and a second party, wherein each of the trade finance documents contains data that identifies the first party, the second party, and a set of terms and conditions of the financial arrangement. The method can also include analyzing, by the computing device and utilizing a document type model, each of the trade finance documents to identify a document type for each of the trade finance documents and identifying, by the computing device, a template for each of the trade finance documents based on its associated document type. Each template can specify one or more possible locations of the data within each of the trade finance documents. The method can also include parsing, by the computing device and utilizing the identified template, each of the trade finance documents with a parser to extract at least a portion of the data from each of the trade finance documents. Further, the method can include transforming, by the computing device, the extracted portion of the data to generate the set of trade finance digital objects corresponding to the trade finance documents. Each of the trade finance digital objects can comprise an electronic replication of the extracted portion of the data that aligns with a trade finance data object model. Additionally, the method can include storing, by the computing device, the set of trade finance digital objects.

In embodiments, the document type can comprise one of an invoice, a purchase order, a bank guarantee, a letter of credit, an insurance certificate, a bill of lading, a logistics document, a customs document, an air waybill, a certificate of origin, an inspection certificate, a bill of exchange, an import declaration, an export declaration, a packing list, a bank payment obligation, and a letter of indemnity.

In embodiments, storing the set of trade finance digital objects can comprise recording each of the trade finance digital objects on a distributed ledger. The distributed ledger can comprise a blockchain.

In embodiments, the document type model can be a classification model.

In embodiments, the template for each of the trade finance documents can be identified from a set of document templates generated via a machine learning algorithm. The machine learning algorithm can be trained via a supervised learning process.

In embodiments, the template for each of the trade finance documents can be identified from a set of manually generated document templates.

In embodiments, acquiring the set of trade finance documents can comprise scanning physical copies of the trade finance documents.

In embodiments, acquiring the set of trade finance documents can comprise receiving electronic versions of the trade finance documents.

In embodiments, the trade finance data object model can specify a set of features for defining the trade finance digital objects.

In embodiments, the set of features for a particular trade finance digital object can be based on the document type of the particular trade finance digital object.

In embodiments, the automated data validation process can comprise generating a validation score corresponding to each of the set of trade finance digital objects, the validation score representing an accuracy and/or completeness of the electronic replication; comparing the validation score to a threshold; and when the validation score satisfies the threshold, validating its corresponding trade finance digital object of the set of trade finance digital objects. The method can further include, when the validation score does not satisfy the threshold, designating its corresponding trade finance digital object of the set of trade finance digital objects as in need of further processing. The further processing can comprise initiating a manual review of it corresponding trade finance document and trade finance digital object.

In embodiments, a computing device that implements a trade finance asset digitization and tracking platform and associated method are disclosed. The computing device can comprise at least one processor and a memory. The computing device can comprise a data digitization engine for generating a set of trade finance digital objects corresponding to a set of trade finance documents of a user. Each of the set of trade finance documents can comprise a record of a financial arrangement between the user and a second party based on a set of terms and conditions. Each of the trade finance digital objects can comprise an electronic replication of data of its corresponding trade finance document that aligns with a trade finance data object model. The computing device can further comprise a monetization engine for aggregating the set of trade finance digital objects. The monetization engine can be configured to determine a value for each trade finance digital object based on the electronic replication of the data of its corresponding trade finance document, determine a cost to access the value for each trade finance digital object at a particular time, and permit the user to transfer ownership of one or more of the trade finance digital objects to another party.

In embodiments, the monetization engine can be configured to output a ranked list of the set of trade finance digital objects based on the costs to access the value for each trade finance digital object at the particular time. The ranked list can be output on a graphical user interface, and/or the ranked list can be automatically updated by the monetization engine.

In embodiments, the monetization engine can determine the cost to access the value for each trade finance digital object at the particular time based on the set of terms and conditions of the financial arrangements. The monetization engine can determine the cost to access the value for each trade finance digital object at the particular time for each of a plurality of funding options. The monetization engine can determine the cost to access the value for each trade finance digital object at the particular time for each of the plurality of funding options based on one or more of: (i) historical pricing of a particular funding option, (ii) a time period between the particular time and a maturation date of each trade finance digital object, and (iii) an identity of the second party. In embodiments, the monetization engine can determine the cost to access the value for each trade finance digital object at the particular time for each of the plurality of funding options based on one or more of: (i) historical pricing of a particular funding option, (ii) a time period between the particular time and a maturation date of each trade finance digital object, (iii) an identity of the second party, (iv) a currency exchange rate, and (v) a jurisdiction associated with each trade finance digital object. The cost to access the value for each trade finance digital object at the particular time for each of the plurality of funding options can be further based on a credit rating. The credit rating can correspond to at least one of the user and the second party.

In embodiments, the trade finance documents of the user can comprise an accounts receivable item, an invoice, a purchase order, a bank guarantee, a letter of credit, an insurance certificate, a bank payment obligation, shipping document, or a letter of indemnity.

In embodiments, the monetization engine can coordinate the transfer of ownership of one or more of the trade finance digital objects to another party.

In embodiments, a computing device that implements a trade finance asset digitization and tracking platform and associated method are disclosed. The computing device can comprise at least one processor and a memory. The computing device can comprise a data digitization engine for generating a set of trade finance digital objects corresponding to a set of trade finance documents of a user. Each of the set of trade finance documents can comprise a record of a financial arrangement between the user and a second party based on a set of terms and conditions. Each of the trade finance digital objects can comprise an electronic replication of data of its corresponding trade finance document that aligns with a trade finance data object model. The computing device can further comprise a cash forecasting engine for aggregating the set of trade finance digital objects. The cash forecasting engine can be configured to determine a liquidity position for the user based on the electronic replication of data of the trade finance documents, and utilize a machine learning model to forecast a cash position of the user at a future date, wherein the machine learning model is trained to detect patterns associated with each of the trade finance digital objects based on historical payment activity of its corresponding party.

In embodiments, the forecast of the cash position of the user can be further based on accounts payable information. The forecast of the cash position of the user can be further based on intracompany flow of capital of the user.

In embodiments, the machine learning model can be trained to detect a payment delay pattern comprising a time difference between a contracted payment date and an actual payment date from the corresponding party.

In embodiments, the machine learning model can be trained to detect a specific day of week pattern comprising a consistent day of week associated with payments from the corresponding party.

In embodiments, the machine learning model can be trained to detect a time period of month pattern comprising a consistent time period of month associated with payments from the corresponding party. The consistent time period of month associated with payments from the corresponding party can correspond to a beginning of the month, a middle of the month, or an end of the month.

In embodiments, the trade finance asset digitization and tracking platform can further comprise a validation engine that is used to update the machine learning model. The validation engine can update the historical payment activity upon which the machine learning model is trained.

In embodiments, the machine learning model can be configured to determine a confidence score of the forecasted cash position of the user at the future date.

In embodiments, the trade finance asset digitization and tracking platform can further comprise a netting engine, the netting engine configured to detect an expected payment from and an expected payment to a particular party. The netting engine can output a notification to the user and the particular party when there is both the expected payment from and the expected payment to the particular party. Upon detection of the expected payment from and the expected payment to the particular party, the netting engine can automatically satisfy one or both of the expected payment from and the expected payment to the particular party.

It is to be understood that any combination of features from the methods disclosed herein and/or from the systems disclosed herein may be used together, and/or that any features from any or all of these aspects may be combined with any of the features of the embodiments and/or examples disclosed herein to achieve the benefits as described in this disclosure.

### BRIEF DESCRIPTION OF THE FIGURES

In the accompanying figures, like reference numerals refer to identical or functionally similar elements throughout the separate views and together with the detailed description below are incorporated in and form part of the specification, serve to further illustrate various embodiments and to explain various principles and advantages all in accordance with the systems and methods disclosed herein.

FIG. 1 is a diagrammatic view that depicts an exemplary an architecture of a trade finance system and the entities constituting the trade finance network in accordance with various embodiments of the present disclosure;

FIG. 2 is a diagrammatic view that depicts an exemplary distributed trade finance network in which a trade finance digital platform is structured to perform trade finance transactions between a seller and buyer in accordance with various embodiments of the present disclosure;

FIG. 3 is a diagrammatic view that depicts executing an exemplary trade finance transaction between a seller and buyer in trade finance network using the trade finance digital platform in accordance with various embodiments of the present disclosure;

FIG. 4 is a diagrammatic view that depicts an exemplary trade finance network and the different entities of the trade finance network supported and managed by the trade finance digital platform in accordance with various embodiments of the present disclosure;

FIG. 5 is a diagrammatic view of an exemplary method of creating a digital trade asset like a trade finance asset in accordance with various embodiments of the present disclosure;

FIG. 6 is a diagrammatic view that depicts an exemplary trade finance digital platform and its components and subsystems in accordance with various embodiments of the present disclosure;

FIG. 7 is a diagrammatic view that depicts an exemplary user interface of the trade finance asset workflow and trading system to manage a set of business processes and workflows at one or more entities of trade finance network in accordance with various embodiments of the present disclosure;

FIG. 8 is a diagrammatic view of an exemplary method of creating a trade finance digital object from a set of trade finance documents in accordance with various embodiments of the present disclosure; and

FIG. 9 is a diagrammatic view that depicts an exemplary trade finance asset digitization and tracking platform and its components and subsystems in accordance with various embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the many embodiments of the systems and methods disclosed herein.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art. The claims should be consulted to ascertain the true scope of the disclosure.

Before describing in detail embodiments that are in accordance with the systems and methods disclosed herein, it should be observed that the embodiments reside primarily in combinations of method and/or system components. Accordingly, the system components and methods have been represented where appropriate by known symbols in the drawings, showing only those specific details that are pertinent to understanding the embodiments of the systems and methods disclosed herein.

All documents mentioned herein are hereby incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth, except where the context clearly indicates otherwise.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one skilled in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “third,” “above,” “below,” and the like, are words of convenience and are not to be construed as implying a chronological order or otherwise limiting any corresponding element unless expressly stated otherwise. The term “set” should be understood to encompass a set with a single member or a plurality of members.

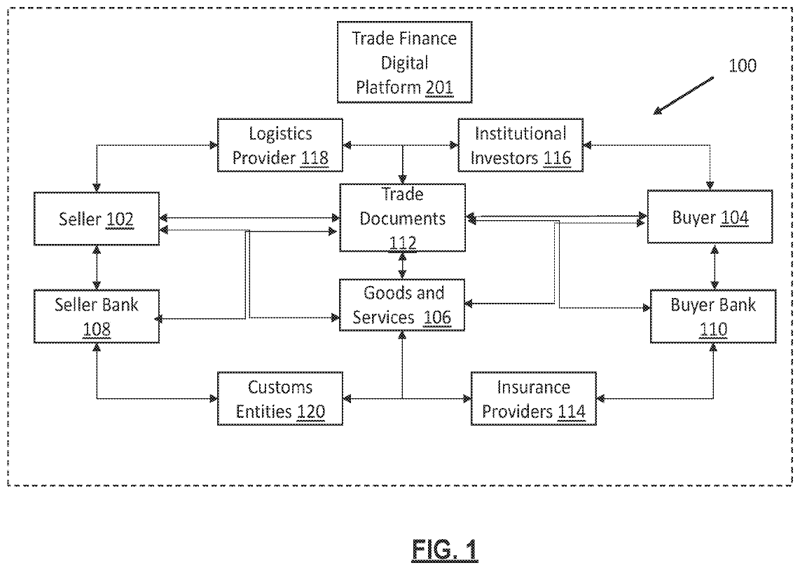

FIG. 1 depicts an architecture of an exemplary trade finance system and the entities involved in and/or constituting a trade finance network or ecosystem 100. A trade transaction between a seller 102 and a buyer 104 for the exchange of goods or services 106 typically requires intermediaries like banks or insurance companies for providing liquidity and/or for underwriting or managing transaction risks. A seller bank 108 and/or a buyer bank 110, where applicable, may support the transaction by assuming the risks and/or providing working capital for the seller 102 and the buyer 104, respectively. These parties may use one or more trade documents 112 (also referred to herein as “trade finance documents”) such as invoices, purchase orders, bank guarantees, letters of credit, bills of lading, etc. to facilitate the transaction and manage risk. Such trade documents 112 can comprise a record (written, electronic, etc.) of a financial arrangement between parties. Such trade finance documents contain data that identifies the parties and a set of terms and conditions of the financial arrangement. For example, a letter of credit is a trade document issued by the buyer bank 110 that assures payment to the seller 102 and allows the seller to demand payment from the buyer bank in case the buyer is unable to make the payment. Insurance providers 114, institutional investors 116, and logistics providers 118 can be the other key intermediaries or service providers that help facilitate trade transactions and manage risks in such transactions. The logistics providers 118 can include freight forwarders, shippers, fulfillment providers, delivery service providers, and the like. Customs entities 120 can help facilitate and/or regulate the flow of goods from the seller 102 to the buyer 104. By way of these examples, the seller 102 can be positioned as sellers linked in a supply chain, sub-component manufacturers and suppliers, original equipment manufacturers, value-added resellers, system integrators, distributors, sales agents, retailers, and other parties. The buyer 104 can be positioned as a set of buyers, including buyers that are resellers, distributors, buyers that are retailers, end customers, combinations thereof and the like. It should be appreciated that additional or alternative entities, although not specifically illustrated, can be involved in the trade finance network or ecosystem 100, including but not limited to other types of trade finance risk mitigation participants such as receivables puts providers and the like.

In the many examples, the trade finance process may be seen as managing the flow of trade documents 112 between the buyer 104, the seller 102 and their respective banks, the flow of goods through the supply chain from the seller 102 to the buyer 104 and the flow of finance from the buyer 104 to the seller 102. The flows of documents, goods and finance in some typical processes may not be well-correlated or well-coordinated. For example, a letter of credit may authorize the release of some amount of funds conditioned on delivery of a bill of lading by the seller, which details the type, quantity and destination of goods to be provided by the seller. The seller would then need to physically courier the bill of lading to the buyer's bank that needs to be reviewed and approved before the transaction is completed and funds are released. The delivery may take several days, errors may occur in the documents, or the documents may turn out to be invalid or fraudulent, any of which can delay or compromise the transaction. In these examples, a trade finance digital platform 201 may connect to or be connected to one or more of the entities (or sets thereof) to facilitate portions of the relationship and more efficient exchange between the entities.

In embodiments, the trade documents 112 may include a wide range of documents used for facilitating trade transaction between buyers and sellers including purchase orders, invoices, air waybills, bills of lading, certificates of origin, inspection certificates, bills of exchange, import and export declarations, packing lists, letters of credit, bank payment obligations, bank guarantees, insurance certificates, letters of indemnity, and others.

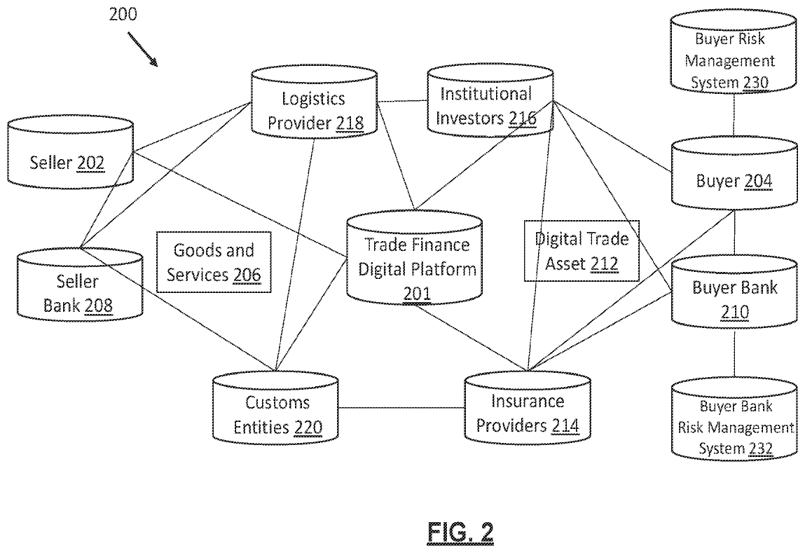

FIG. 2 illustrates a distributed trade finance network 200 in which a trade finance digital platform 201 is structured to enable trade finance transactions among sets of sellers 202 and sets of buyers 204. In embodiments, the trade finance digital platform 201 may be implemented using a decentralized, peer-to-peer blockchain network with the different entities of the network having distributed computing nodes of the blockchain, such as nodes for sellers 202, buyers 204, seller banks 208, buyer banks 210, insurance providers 214, institutional investors 216, logistics providers 218 and customs entities 220, in contrast to what is depicted in FIG. 1. In embodiments, the different entities of the network having distributed computing nodes of the blockchain may also include nodes for a buyer risk management system 230 and a buyer bank risk management system 232. In such embodiments, a distributed computing node may comprise a computing device having a processor and a computer-readable medium having machine-readable instructions stored thereon and may contain a full record of the transaction history of the blockchain, such as a distributed ledger of transactions, events, actions and other activities involving data processed by the distributed computing nodes. In many examples, nodes may be implemented in a variety of computing systems including banking systems, enterprise systems, inventory management systems, shipping and/or delivery tracking systems, SKU databases, and the like. In embodiments, whenever additional transactions are proposed to be added to the blockchain, one or more of the nodes may validate the proposed additional transaction records, such as via a consensus algorithm. Typically, once the proposed transaction has been validated e.g., through the consensus algorithm, the proposed transaction can be added to each copy of the blockchain across all the nodes.

The trade documents 112, which may be used by the entities of the distributed trade finance network 200 to facilitate the transaction, can be digitized to create digital trade assets 212 and, in embodiments, may be stored on the blockchain or other storage system. Further, the digital trade assets 212 may be structured as smart contracts to help automate workflows in the trade finance network 200. The advantages to implementing the trade finance network 200 as a blockchain may include ensuring efficient and secure trade transactions, providing a unified view and real time access to trade transaction information to different entities of the trade finance network 200, and providing relatively quicker and simpler processing of trade documents through automated workflows. Further, blockchain-based trade finance network implementation can link the workflows involved in documents (including legal documents, insurance policies/documents and others), goods, and finances, thereby helping in better real-time visibility and better management of risks associated with trade financing. In embodiments, the digital trade assets 212 as described herein may include trade finance assets, trade credit insurance assets, working capital loan assets, commercial loan assets, and the like.

In embodiments, the trade finance digital platform 201 may create a digital trade asset 212 referred to interchangeably in some cases herein as a digital trade object, a trade finance data object, a trade finance object, a trade finance digital object, or the like. The trade finance digital platform 201 may create a digital trade asset 212 each time a new trade transaction is initiated between a seller and a buyer. This digital trade asset 212 may be created, for example, by ingesting one or more trade documents 112 such as via various data ingestion modes including parsing systems, NLP systems, text recognition systems, and others that recognize native data types for purposes of further processing). Data is extracted from the trade documents and aligned with a trade finance data model such as involving normalization of data, transformation of data to a set of data types used by the trade finance data model, and loading of data to appropriate components of such a trade finance data model. In embodiments, the digital trade asset 212 may continue to be updated, such as by adding transaction and event data related to one or more events occurring in a trade finance workflow, as further described herein.

In embodiments, data of a digital trade asset 212 or of a data model may be verified by a set of distributed nodes, such as by a trusted party. In embodiments, data of a digital trade asset 212 or of a data model may be verified by a distributed consensus algorithm, such as the Raft consensus algorithm, a Byzantine Fault Tolerant algorithm (BFT) or the like. In embodiments, verified data may be hashed into an ongoing chain of cryptographically approved blocks of transaction records constituting a blockchain for the trade finance platform 201. In embodiments, the consensus algorithm may be a “practical byzantine fault tolerance” (“PBFT”) algorithm, in which each node validates pending transaction records by using a stored internal state within the node. In many examples, a user or node may submit a request to post a pending transaction record to the blockchain. Each of the nodes in the blockchain may then run the PBFT algorithm using (i) the pending transaction record and (ii) each node's internal state to, in turn, formulate a conclusion about the pending transaction record's validity. Upon reaching said conclusion, each node may submit a vote (e.g., “yes” or “no”) to the other nodes in the blockchain A consensus can be reached amongst the nodes by considering the total number of votes submitted by the nodes. Subsequently, once a threshold number of nodes have voted “yes,” the pending transaction record can be treated as “valid” and is thereafter appended to the blockchain across all of the nodes.

In embodiments, a blockchain may be a private and permissioned blockchain controlled by a single entity or a consortium of trusted entities, such as one that is built using pre-built API provided on, for example, CORDA, Hyperledger, or Quorum, as well as chaincode languages such as Golang, Javascript, Java, Kotlin, or DAML, among others.

In embodiments, the blockchain may be a public, permissionless blockchain In embodiments, the event data related to the movement of goods through the supply chain in the trade finance network may be tracked using various IT systems of the entities involved.

In embodiments, transaction records stored in a blockchain may be hashed, encrypted, or otherwise protected from unauthorized access and may only be accessible utilizing a private key to decrypt the stored information/data.

In embodiments, the blockchain may be a single blockchain configured for storing all transactions therein, or it may comprise a plurality of blockchains where each blockchain is utilized to store transaction records indicative of a particular type of trade finance transaction. For example, a first blockchain may be configured to store shipment data and supply chain transactions, and a second blockchain may be configured to store financial transactions (e.g., via a fiat currency, a virtual currency or other form of value). In yet another example, multiple blockchains can be linked together to drive activity and/or provide a combined historical view of a digital trade asset 212, such as a first blockchain to store transaction records from an order to cash transaction related to a digital trade asset 212, a second blockchain to store records related to trade financing of the digital trade assets 212 in the first blockchain, and a third blockchain to store records related to any insurance policy(ies) and/or linking of the digital trade assets 212 in the second blockchain The linking of the first, second, and third blockchains can provide an overall, holistic view of the lifecycle of a digital trade asset 212.

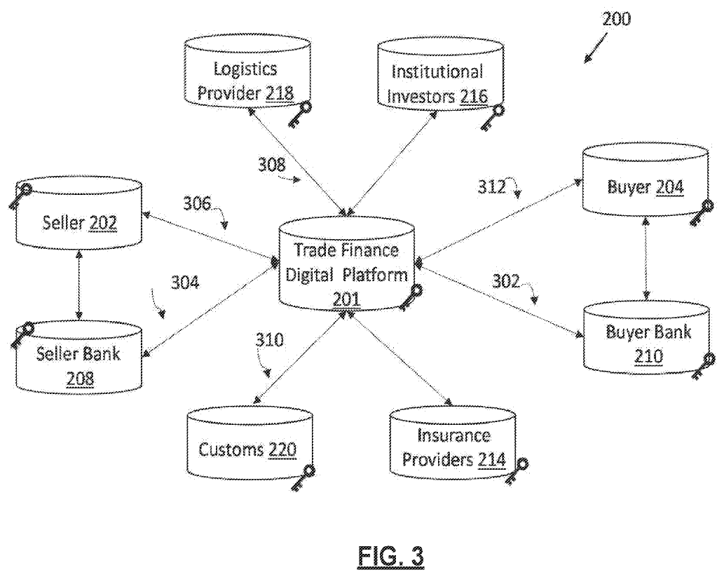

FIG. 3 illustrates exemplary methods for executing an exemplary trade finance transaction between a seller 202 and buyer 204 in the trade finance network 200 using the trade finance digital platform 201. Upon signing of a trade purchase agreement between the seller 202 and the buyer 204, at 302, the trade purchase agreement can be shared with the buyer bank 210, such as by using a smart contract that embodies the terms of the trade purchase agreement and that is associated with one or more distributed ledgers (e.g., a blockchain). In embodiments, a party, such as the buyer bank 210 may review the trade purchase agreement, draft terms of credit and submit an instruction regarding the obligation to pay to the seller bank 208. At 304, the seller bank 208 may review and approve the instruction regarding the obligation and generate a smart contract on the blockchain to cover the terms and conditions of the agreement. The seller bank 208 may share the smart contract embodying the obligations with the seller 202. Upon reviewing the obligations, the seller 202 may provide a digital signature of approval to the blockchain-based smart contract and initiate shipment of goods at 306.

In embodiments, the logistics provider 218 may inspect the shipment of goods and provide digital signature of approval to the blockchain-based smart contract at 308. The logistics provider 218 may then transport the goods from one country to the other and present them to the customs entities 220.

In the previously mentioned scenarios, participants must follow the standards/capabilities of conventional blockchain technology, as blockchain platforms typically allow the exposure of terms and conditions information in the code of the blockchain.

In embodiments, the methods and systems disclosed herein include a framework that can provide the capability to abstract details of terms and conditions away, if so desired, and certain examples of the framework its features can be referred to as an InBlock framework or InBlock features. This framework can be shown to allow participant to maintain privacy on the terms and conditions in the smart contract. Thus, the platform can be shown to increase privacy, simplify maintenance and de-risk the exposure of transaction data. In those instances, participants on the blockchain are prevented from gaining access to the business logic contained within the chain code. By way of these examples, the chain code can have a design pattern that can purposefully obfuscate the codified terms and conditions while leaving the application access method or “processor” of the smart contract as simply, in many examples, a function comprised of logic in a JSON file. For small network ecosystems (or in the case of ecosystems that use a Hyperledger, a single channel of few participants), it is appreciated in light of the disclosure that deploying the application access method of the smart contract as simply a function comprised of logic in a JSON file and this not problematic because there simply would be a few channels each with a few participants. For large scale ecosystems, an approach of using “one channel with total transparency,” in many examples, can be deployed as a direct challenge to private multi-node network scalability, especially given the nature of some of the consensus/data reconciliation performance issues with blockchain that can occur with many nodes on one channel. The methods and systems disclosed herein can provide for one channel but with privacy and control on that one channel. In embodiments, a fine-grained entitlement system may be integrated into and deployed the functionality of the authorization capabilities of the distributed ledger as a subset of the application logic available under the framework and certain exemplary functionalities may be referred to as InBlock functionalities.

Similarly, one of the customs entities 220 may also digitally sign the blockchain-based smart contract, such as upon inspection at 310. Upon delivery of goods, the buyer 204 may digitally acknowledge the receipt of goods at 312. By way of these examples, the blockchain-based smart contract may then trigger the payment to the seller, such as automatically upon receiving the acknowledgement of delivery of goods.

In embodiments, the trade finance digital platform 201, optionally implemented on the blockchain, provides the various entities in the trade finance network 200, including sellers, buyers, seller banks, buyer banks and insurance companies, among others, with significantly better user experience workflow as compared to traditional trade finance systems. In embodiments, the user experience workflows of the trade finance digital platform 201 may allow the various entities in the trade finance network 200 to, among other things: digitize trade documents and assets to create a class of digital trade assets in a trade finance network; provide real time visibility of such assets for all the entities of the trade finance network; securitize and tokenize such digital trade assets to provide liquidity for such assets; enable real time settlement of trade transactions; enable all the entities of a trade finance network to track the movement of goods from a seller to a buyer through a supply chain network; view the status of a trade transaction between a seller and a buyer of a good and provide services based on the status; forecast cash flow based on the status of one or more trade transactions with one or more counterparties; automatically track and report on state information for a digital trade asset; automatically handle the timeliness of workflows for the digital trade finance asset; automatically handle the trade finance transaction including creation of a digital trade asset, processing of payment for the transaction, settlement and reconciliation of the trade transaction; automatically handle the legal and compliance framework around a class of a digital trade asset; and automatically resolve cash positions based on events tracked in the trade finance digital platform.

Additionally, the trade finance digital platform 201 may provide the following advantages to the entities of the trade finance network 200 that may be engaged in a trade transaction over platform 201: an accelerated cycle time for the trade transaction; reduced exposure to financial, counterparty, and documentation risks; reduced reliance on manual review, preparation and processing of the trade documents; reduced operational overhead incurred in document creation, acceptance and verification; facilitation of non-repudiation of terms and conditions of a trade transaction; immutable trade finance instruments, securely encoded and authenticated in the ledger; immutable auditing and tracking of the entire trade/finance process; real-time reconciliation and settlement of the payments; and reduced exposure to disputes and fraud risks, among others.

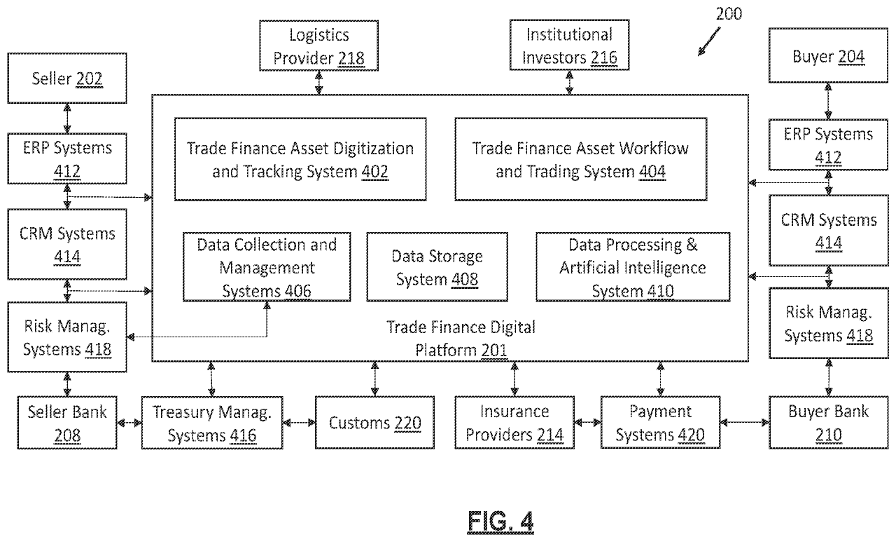

FIG. 4 depicts the trade finance network 200 and the different entities of the trade finance network supported and managed by the trade finance digital platform 201. In embodiments, the trade finance digital platform 201 comprises a trade finance asset digitization and tracking system 402 for digitizing a set of trade finance data objects (including document objects), including a set of trade finance agreements, legal contracts, purchase orders, invoices, shipment data, bills of lading, certificates of origin, inspection certificates, bills of exchange, import and export declarations, packing lists, letters of credit, and/or bank payment obligations. The trade finance asset digitization and tracking system 402 may extract data from the trade finance agreements/assets and transform the data to fit a data model to create an investible digital trade asset, such as a digital trade finance asset. This digital trade finance asset may be structured as a smart contract and stored on a blockchain. This enables real time tracking and updates on trade documents and finance flows, thereby allowing for better risk allocation and deployment for banks, insurers and other parties, as well as partial and incremental financing for the seller.

In embodiments, the trade finance digital platform 201 may also include a trade finance asset workflow and trading system 404 for managing and streamlining the workflow of the trade finance asset and for distributing and trading of the trade finance asset among institutional investors 216. The trade finance asset workflow and trading system 404 may have a user interface that provides a set of unified views for a set of asset workflow and trading applications for the trade finance asset. The asset workflow and trading applications may include trade finance applications, workflow management applications, treasury management applications, risk management applications, pricing applications, trade credit insurance applications, trade credit insurance underwriting applications, reporting applications and trading applications. These applications may enable the seller 202, buyer 204, seller bank 208, buyer bank 210 and other entities of the trade finance network 200 to perform a range of functions including visualizing and configuring workflows, pricing of activities involving the trade finance asset (such as setting interest rates for credit and premiums for insurance coverage), identifying potential buyers for the trade finance asset, buying and selling of the trade finance asset, and the like.

The trade finance digital platform 201 may also include data collection and management system 406, data storage system 408, and data processing and artificial intelligence system 410. The data collection and management system 406 may collect and organize data collected from the trade finance network 200, including data from the events, transactions, activities and entities in the trade finance network. This may include data stored at and managed by one or more third party systems including Enterprise Resource Planning (ERP) systems 412, Customer Relationship Management (CRM) Systems 414, Treasury Management Systems (TMS) 416, Risk Management Systems 418, and payment systems 420, such as the SWIFT (Society for Worldwide Interbank Financial Telecommunication) payment system. In embodiments, the trade finance digital platform 201 may have an integration service configured to provide integration of the trade finance digital platform with such third-party systems and data collection, and the management system 406 may collect trade transaction related data from such systems. In many examples, the data storage system may store the various data collected about events, transactions and entities in the trade finance network 200 such that any of the services, applications, programs, or the like may access a common data source, e.g., a common data that may include a single logical data source that is distributed across disparate physical and/or virtual storage locations. In embodiments, the data processing and artificial intelligence system 410 may facilitate development and deployment of automation, machine learning, artificial intelligence, analytics, monitoring, reporting, state management, process management, and many others, for a wide variety of trade finance network applications and end uses. By way of these examples, the data processing and artificial intelligence system 410 may train models such as pricing models, predictive models, models that operate on smart contract data, classification models, and models used to configure or optimize workflows (e.g., various types of neural networks, regression-based models, and other machine-learned models). In embodiments, the training can be supervised, semi-supervised, or unsupervised. In embodiments, training can be done using training data, which may be collected or generated for training purposes. In embodiments, data processing and artificial intelligence system 410 trains a pricing model to generate the pricing for the digital trade assets. Some other examples of artificial intelligence applications deployed by data processing and artificial intelligence system 410 may include: determining a credit risk score for a digital trade asset; identifying transactions with compliance concerns; and predicting timeliness and extent of payment on trade finance receivables. Examples of machine learning technology that can be used in accordance with the present disclosure include, but are not limited to, Azure ML, Psykit, Tesseract, BERT, EasyOCR, GoogleOCR, fuzzy-match, fuzzywuzzy, and Keras.

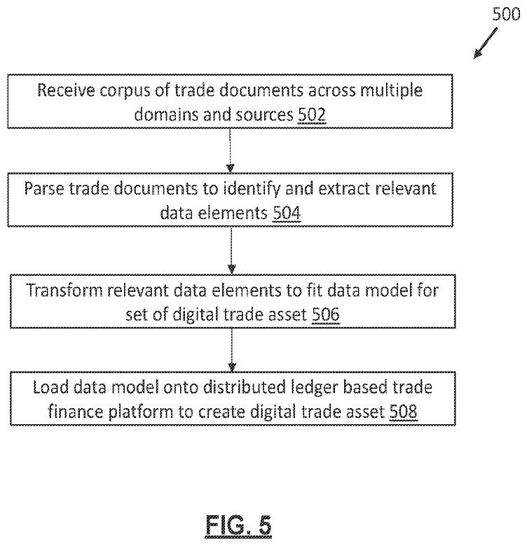

FIG. 5 depicts exemplary methods of creating a digital trade asset like a trade finance asset, at 500. At 502, a corpus of trade documents is received at trade finance asset digitization and tracking system 402 of the trade finance digital platform 201. In embodiments, the trade documents may be uploaded on a graphical user interface of trade finance asset digitization, and the tracking system 402 and may receive and track invoices, purchase orders, insurance policies, loans, letters of credit, trade finance agreements, supporting data like payment terms, cashflow data, shipping data and so on. At 504, the trade documents are parsed to identify, extract and optionally normalize relevant data elements with intelligence to dissect the ingested assets from a macro-level down to the atomic level where each granular data item can then be analyzed for what is at 506. There are various adapters that may define and add awareness of the structure, sequencing and, to a degree, definition of the data, which helps to inform the system for what is at 506. While the process of parsing can be valuable, in trade finance environments, there are typically many unusual data structure scenarios that can result in significant problems for traditional systems that are engineered with too many assumptions about commonality and consistency of data structures. In accordance with the present disclosure, it is appreciated that improved parser intelligence and alerting can help to maintain continued production flow of data by taking action when an exception occurs. In embodiments, an exception is first analyzed by machine for characteristics, behaviors, and/or patterns that may “heal” the parser exception. When the machine analysis cannot heal the ingestion activity, then a workflow may be initiated to involve a human, which should be rare if prior services are engineered with a proper level of thoughtfulness. At 506, the relevant data elements extracted from trade documents are optionally normalized and/or transformed to fit a data model for a set of digital trade assets. In these examples, use of AI/ML and utilities, such as NLP, vocabulary “adapters,” or both, that are specific to trade asset classes and their associated data models can be beneficial. It will be appreciated in light of the disclosure that the intelligence of the system brings this data to life, which adds significant value relative to a traditional “digitized” asset that has been commonly turned into bits-and-bytes without any level of understanding of the asset's structure, definition, intention, lifecycle and even owner history. Moreover, the data models disclosed herein can also tie into entitlements specifications so as to ensure privacy of digital assets overall including at the atomic level. At 508, the data model is loaded onto the trade finance digital platform to create a digital trade asset.

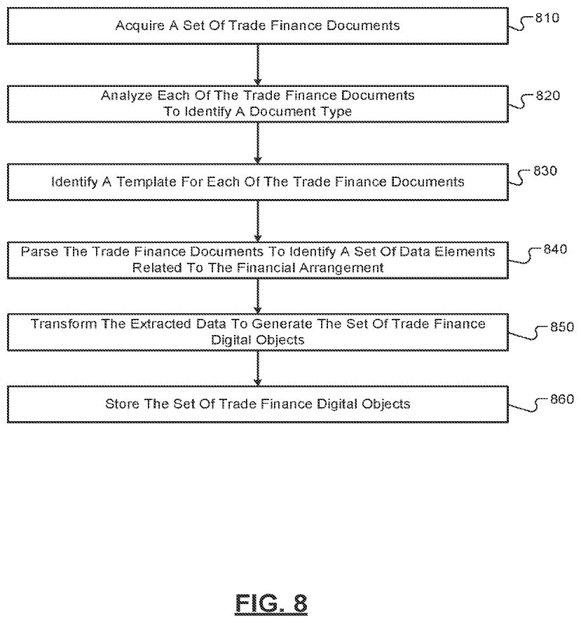

With continuing reference to FIG. 5, in some embodiments, the trade finance digital platform 201 can generate a set of trade finance digital objects (digital trade assets 212) from a set of trade finance documents 112. As described above, trade finance digital objects can be structured as smart contracts to help automate workflows in the trade finance network 200. Such trade finance digital objects (“smart contracts”) have many advantages, including ensuring efficient and secure trade transactions, providing a unified view and real time access to trade transaction information to different entities of the trade finance network 200, providing relatively quicker and simpler processing of trade documents through automated workflows, linking the workflows involved in documents (including legal documents, insurance policies/documents, purchase/order documents, shipping documents, and any other type of document such as those discussed herein), goods, and finances, and providing enhanced visibility (e.g., real time) and better management of risks associated with trade financing. An example method 800 for generating such trade finance digital objects (digital trade assets 212) from a set of trade finance documents 112 is described with further reference to FIG. 8. For ease of description, the method 800 will be described as being performed by a computing device having one or more processors. It should be appreciated, however, that the method can be performed by any type of network infrastructure, including but not limited to a single computing device acting alone, a single computing device communicating with one or more other types of network infrastructure, and/or a plurality of computing devices acting in a coordinated manner.

At 810, the computing device can acquire a set of trade finance documents 112. As mentioned above, each trade finance document can comprise a record of a financial arrangement between various parties, such as a first party and a second party. The each of the trade finance documents can contain data (information, text, metadata, etc.) that identifies the parties involved and a set of terms and conditions of the financial arrangement. For example only, the trade finance document can comprise a physical document, such as an invoice, a purchase order, a bank guarantee, a letter of credit, an insurance certificate, a bill of lading, a logistics document, a customs document, an air waybill, a certificate of origin, an inspection certificate, a bill of exchange, an import declaration, an export declaration, a packing list, a bank payment obligation, or a letter of indemnity. In other cases, the trade finance document can comprise an electronic file or data. The computing device can acquire the trade finance document in various ways, including by scanning a physical document, receiving an electronic document or data, or the like. It should be appreciated that any appropriate ingestion model may be utilized with the present disclosure.

At 820, the computing device can analyze each of the trade finance documents to identify a document type for each of the trade finance documents. In embodiments, a document parser may scan and analyze the content in the trade finance documents, such as using lexical analysis, natural language processing, or other parsing capabilities known to the art. The document parser can utilize a document type model that is trained to identify a type of the trade finance documents. The document type model can be an artificial intelligence/machine learning system or model that is trained to identify document types based on various features. In some embodiments, the document type model can comprise a classifier or classification model for classifying an unknown document as one of a class of document types. Such document types can include an invoice, a purchase order, a bank guarantee, a letter of credit, an insurance certificate, a bill of lading, a logistics document, a customs document, an air waybill, a certificate of origin, an inspection certificate, a bill of exchange, an import declaration, an export declaration, a packing list, a bank payment obligation, and a letter of indemnity, although any other document type is within the scope of the present disclosure.

Based on the determined document type, at 830 a template for each of the trade finance documents can be identified. In some embodiments, and as more fully described below, each template can specify one or more possible locations of the relevant data within each of the trade finance documents. In this manner, the computing device can utilize the identified template, at 840, to parse (e.g., with a parser) each of the trade finance documents to extract at least a portion of the data from each of the trade finance documents to identify a set of data elements related to the financial arrangement between the parties. At 850, the computing device can transform the extracted portion of the data to generate the set of trade finance digital objects 212 corresponding to the trade finance documents. As mentioned above, each of the trade finance digital objects 212 can comprise an electronic replication of the extracted portion of the data that aligns with a trade finance data object model. In embodiments, the trade finance data object model specifies a set of features for defining the trade finance digital objects 212, and the set of features for a particular trade finance digital object 212 is based on the document type of the particular trade finance digital object. Accordingly, various different trade finance data object models can be used, e.g., depending on the document type. The set of trade finance digital objects 212 can be stored (at 860) by the computing device. In some aspects, the storing of the set of trade finance digital objects can comprise recording each of the trade finance digital objects 212 on a distributed ledger, e.g., a blockchain, as described herein.

The templates that specify one or more possible locations of relevant data within a specific type of trade finance document can be generated via a machine learning algorithm. In some embodiments, the machine learning algorithm is trained via a supervised learning process. In additional or alternative embodiments, the template for each of the trade finance documents 112 is identified from a set of manually generated document templates, e.g., generated and/or curated by a human. For example only, trade finance documents can be uploaded and displayed on a graphical user interface of a computing device, and a user may select portions, locations, etc. of relevant data and mark, tag, or otherwise link such locations to features for defining the trade finance digital objects 212 specified in a trade finance data object model. It should be appreciated that such manually generated document templates may also be utilized as training data for the machine learning algorithm described above.

The computing device can also perform an automated data validation process 900 to validate each of the stored set of trade finance digital objects 212. In embodiments, the automated data validation process can include generating a validation score corresponding to each object of the set of trade finance digital objects 212 that represents an accuracy and/or completeness of the electronic replication of the trade finance document 112. In embodiments, the validation score represents a confidence score of the machine learning algorithm representative of a likelihood that a trade finance digital object 212 “matches” its corresponding trade finance document 112. Such validation scores can be compared to a threshold, such as a threshold that represents what is deemed to be a sufficient accuracy level for the trade finance digital platform 201. When a validation score for a particular trade finance digital object 212 satisfies the threshold, the particular trade finance digital object can be validated and accepted into the trade finance digital platform 201 for further processing, etc. When the validation score does not satisfy the threshold, however, the trade finance digital platform 201 may designate the particular trade finance digital object 212 as in need of further processing. Such further processing can include, e.g., initiating a manual review of the particular trade finance digital object and its corresponding trade finance document, and/or selecting a different document type template during the process of generating the particular trade finance digital object.

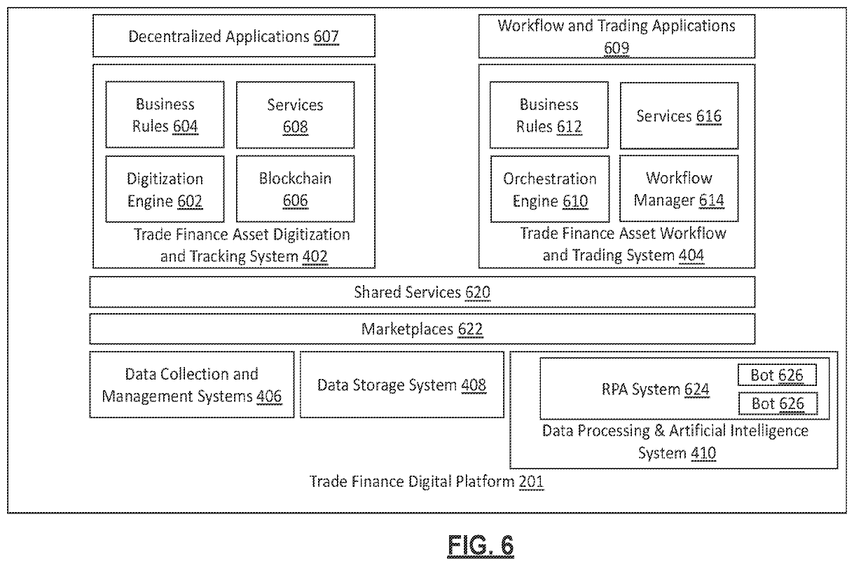

FIG. 6 depicts the trade finance digital platform 201 and its components and subsystems in accordance with various embodiments. In embodiments, the trade finance asset digitization and tracking system 402 may include a digitization engine 602 that receives the trade documents via a graphical interactive interface of the trade finance asset digitization and tracking system 402. In embodiments, a document parser in the digitization engine 602 may scan and analyze the content in the trade documents, such as using lexical analysis, natural language processing, or other parsing capabilities known to the art. Based on the result of lexical analysis, the parser may identify a set of data elements for extraction. For example, such data elements may include company name, company address, bank name, insurance policy number, BIC code, known legal clauses (such as the “Red clause” where an unsecured letter of credit is extended), and beneficiary bank. In these examples, a data processing module in the digitization engine may then transform the extracted data to fit and align with a data model that is configured to handle and normalize handling of trade finance workflows and activities. In embodiments, the data model may be a universal data model capable of handling a variety of trade finance activities, entities, objects and workflows, or it may be domain-specific, such as for handling legal perfection (such as of security interests, title, or the like) or other activities in a given jurisdiction, of a given type, or the like. The transformation to a data-model suitable state may involve linking to a representation of the legal framework applicable to the trade documents, such as the jurisdiction and/or particular code or law recited in a legal contract that applies to the transaction (such as one is already embodied in a smart contract or that can be embodied in one), which, in embodiments, may embody the overarching legal framework applicable to trade finance network activities in a relevant jurisdiction and, in embodiments, may link to external systems, such as systems for Uniform Commercial Code (UCC) filings and others. In embodiments, the processing module may apply a set of business rules 604 to transform raw data records into model records, the model records representing instances of data objects that are consistent with the data model. In these examples, the model records may then be stored on the blockchain 606 to create a digital trade asset of record that provides benefits of visibility, security, tracking, recordkeeping, analysis, trading, and processing (including smart contract operation and other automated processing, as well as facilitated interaction with other systems and platforms).

In embodiments, the blockchain 606 may enable all entities involved in the trade transaction to update the conditions and/or documents in the blockchain. In some instances, this may allow for close to real time status of a trade finance process to be available to the various entities in the trade finance network 200. In embodiments, business rules 604 may be associated with consensus requirements for updating blocks, adding blocks and deleting blocks, validating new blocks, rejecting new blocks, etc.

In embodiments, a set of decentralized applications 607 running on the platform and optionally interacting with the blockchain 606 may perform various tasks, such as allowing the entities in the trade finance network 200 to access information and collaborate with one another. Some examples of decentralized applications 607 provided on the asset digitization and tracking system 402 include applications for payments, fund transfers, reconciliations, reporting, analytics, cryptocurrency, asset management, decentralized exchanges, supply chain and so on. In embodiments, the applications can reside on the decentralized/distributed containers that also serve as host to the blockchain nodes. In these examples, the distributed applications can also run health monitoring services that can report back to the platform. By way of these examples, the distributed applications can have intelligence to shut-down micro-services and recover gracefully from any disruptive event. In embodiments, local integration to on-premises systems may also comprise part of the design architecture.

In embodiments, the digital trade asset may be structured as or associated with a smart contract, optionally using the blockchain 606, and processing data that is handled within the platform to help automate one or more workflows. In embodiments, services 608 may include a set of services, such as identity services, transaction services, data workflow/validation services, security services, and/or analytics/intelligence services provided by trade finance asset digitization and tracking system 402. In embodiments, a graphical interactive interface of the trade finance asset digitization and tracking system 402 may include a set of wizards for helping a user interact with the system 402 and perform a set of functions. For example, an asset creation wizard may guide a user through digitization of one or more trade documents to create a digital trade asset. Similarly, a smart contract configuration wizard may help a user in structuring and configuring a set of smart contracts for automating workflows in a trade finance network.

In embodiments, the structuring of a digital trade asset as a smart contract, optionally on or more distributed ledgers, automates a trade finance workflow by defining inputs and triggers for a set of events and actions in the trade finance network 200 that embody execution of elements of a set of transactions within the smart contract itself. The smart contracts terms and conditions are automatically executed upon the occurrence of such events or transactions, as recognized by input data, such as events occurring in the platform 201, changes to data objects, inputs from other systems, and other inputs. The provisioning and configuration of various business rules 604, triggers, and conditions may aid in the automated execution between transacting entities, which may help reduce and/or eliminate coordination and operational overhead. Examples of the platforms described herein may be referred to as the InBlock and LiquidX platforms. In embodiments, the platform 201 can offer extensive control over the blockchain ecosystem such that logic, transactions and overall control ultimately roll up to the platform level depending on terms and conditions of the participants and/or specific assets. In many examples, this allows for control and throttling of automation as customers become more familiar and embrace the full functionality that automation offers. Some examples of trade finance workflow that may be automated using smart contracts include: requesting quotes from supply chain counterparties; validating the sale of goods related to the invoice upon receiving the digital signatures of the transacting entities; initiating shipment of goods from the seller to the buyer upon receiving a digitally signed letter of credit; processing partial payment upon occurrence of a supply chain event corresponding to the physical movement of goods along the supply chain; processing partial payment upon delivery of goods to the buyer in accordance with the terms and conditions of the trade transaction; automatically processing an insurance claim upon non-payment of the invoice; automating application of a set of eligibility criteria to filter prospective counterparties for a set of trade finance agreements; automating a risk management workflow with respect to a set of trade finance transactions for a lender or insurer; automating workflows for insurance reporting; and handling of jurisdictional factors in a trade finance platform involving digitized trade finance asset; among others.

The trade finance asset workflow and trading system 404 has a user interface that provides a set of unified views for a set of asset workflow and trading applications 609 for digital trade assets. The asset workflow and trading applications 609 may include trade finance applications, workflow management applications, treasury management applications, risk management applications, pricing applications, reporting applications and trading applications, among others. In embodiments, an orchestration engine 610 can facilitate the creation and management of business rules 612, logic and policies related to registration and onboarding of an entity onto the trade finance digital platform 201, credit and risk management, payments, insurance and compliance etc. The orchestration engine 610 may process a set of production or inference rules and may also detect and manage reaction to various events in the trade finance network 200. Some examples of business rules 612 in the trade finance asset workflow and trading engine 404 may include: “generate an alert on finding a matching counterparty for a trade transaction,” “do not perform a credit check for a returning user,” “generate an acknowledgement once a payment for a trade transaction has been processed,” and so on.

In embodiments, a workflow manager 614 can control a set of workflows related to various events, activities and transactions in the trade finance network 200. In embodiments, services 616 may include a set of services performed by the trade finance asset workflow and trading system 404, such as an order management service to facilitate and manage a buy or sell order for a trade finance digital asset; a matching service to match sell orders or asks for a digital asset with a buy order or bid for executing a trade; an alert service to provide real time alerts and notifications to buyers/sellers notification on finding a match; an auctioning service or other engagement protocol to offer a digital asset to a set of buyers on the platform; a machine-learning based reconciliation service between payments and invoices, a settlement service to enable real time settlement of trade transactions; an analytics service to provide data analytics around treasury management, risk management, asset pricing, and so on; a prediction and forecasting service to enable one or more entities of a trade finance network make predictions about one or more trade finance metrics; and others.

In embodiments, an analytics service determines the risk of a trade finance transaction between one or more entities of the trade finance network, wherein the risk is a function of a set of factors including, for example, credit risk, country risk, currency risk, market risk, transport risk etc. In embodiments, the analytics service determines the price of a digital trade asset based on the risk associated with the asset.

In embodiments, prediction and forecasting service enables one or more entities of a trade finance network to forecast cash flow based on the status of one or more trade transactions with one or more counterparties. In embodiments, prediction and forecasting service enables one or more entities of a trade finance network to predict the timeliness and extent of payment on trade finance receivables. In embodiments, prediction and forecasting service enables one or more entities of a trade finance network to predict an expected default rate for a set of trade finance receivables.

In embodiments, the trade finance digital platform 201 also includes a set of shared services 620 that are shared between both trade finance asset digitization and tracking system 402 and trade finance asset workflow and trading system 404. In embodiments, these shared services 620 may include, for example: an authentication service configured to authenticate the identity of users of trade finance digital platform; an entitlement service to define the roles and access privileges of users of the trade finance digital platform; a reporting service configured to report the status of the trade finance network to the various entities of the trade finance network; an instant messaging service configured to enable the entities in the trade finance network to communicate with each other in real time; a compliance service configured to perform KYC (know-your-customer), KYT (know-your-transaction) and AML compliance checks on users of the trade finance digital platform and on the underlying trade finance transactions themselves; and an integration service configured to provide integration of the trade finance digital platform with a third-party system such as an Enterprise Resource Planning system, a Customer Relationship Management system, a Treasury Management System, and/or a SWIFT system, among others. In embodiments, KYT services may, for example, parse shipping information for vessel names and other identifying information and link to vessel screening lists, such as to insure there are no prohibitions or limitations on the vessel involved in a trade activity.

In embodiments, the trade finance digital platform 201 may also include primary and secondary marketplaces 622 for the trading and financing of standardized digital assets, such as by financiers and institutional investors. The marketplaces 622 may provide additional liquidity for the digital trade assets and enable the entities in the trade finance network to create pools of assets and pools of liquidity, such as to attract other financiers and institutional investors for investing in the digital trade finance assets.

In embodiments, the data processing and artificial intelligence system 410 in the trade finance digital platform 201 has a robotic process automation (RPA) system 624 including one or more software bots 626 for the automation of high volume, repeatable processes. In these examples, the RPA system 624 may be embodied as specialized computer software or hardware whereby an artificial intelligence/machine learning system may be trained on a training set of data that consists of tracking and recording sets of interactions of humans as the humans interact with a set of interfaces, such as graphical user interfaces. The RPA system may be installed on a device so as to mimic user interaction with the graphical user interface of a user device and repeat one or more tasks assigned to or stored in the RPA system 624.

In addition to tracking and recording human interactions, the RPA system 624 may, in embodiments, also track and record a set of states, actions, events and results that occur by, within, from or about the systems and processes with which the humans are engaging. For example, the RPA system 624 may record mouse clicks on a frame of video that appears within a process by which a human reviewed the video, such as where the human highlights points of interest within the video, tags objects in the video, captures parameters (such as sizes, dimensions, or the like), or otherwise operates on the video within a graphical user interface. In embodiments, the RPA system 624 may also record system or process states and events, such as recording what elements were the subject of interaction, what the state of a system was before, during and after interaction, and what outputs were provided by the system or what results were achieved. Through a large training set of observation of human interactions and system states, events, and outcomes, the RPA system 624 may learn to interact with the system in a fashion that mimics that of the human. In these examples, learning may be reinforced by training and supervision, such as by having a human correct the RPA system as it attempts in a set of trials to undertake the action that the human would have undertaken (e.g., tagging the right object, labeling an item correctly, selecting the correct button to trigger a next step in a process, or the like), such that over a set of trials the RPA system 624 becomes increasingly effective at replicating the action the human would have taken.

In many examples, software bots 626 in the RPA system 624 may be embodied as dedicated customized software configured to perform simple tasks such as web scraping, screen-scraping, gathering, entering, migrating or comparing data and executing slightly more complex tasks such as those tasks described herein typically on the back-end of a computing system or device. In embodiments, one or more of the bots 626 may be configured to execute tasks by interacting with applications within the trade finance digital platform 201 only at the interface level (i.e., by providing inputs to the interfaces of the applications).

In embodiments, the RPA system 624 may be used to learn to, among other things: capture, extract and classify key information from a set of trade documents; manage the automation of reconciliation of data records at one or more entities of the trade finance network; manage the automation of compliance requirements of one or more entities of the trade finance network; manage the automation of back office operations at one or more entities of the trade finance network; manage the automation of accounts payable and accounts receivables processes at a bank; manage the automation of trade credit insurance policy administration and servicing process at the insurance provider; manage the automation of trade credit insurance policy underwriting and pricing at the insurance provider; managing trade credit insurance policy reporting and administration; compare the terms of different contracts or insurance policies; and select an optimal path or sequence of actions in a workflow, process or other activity that involves dynamic decision-making, and many others.

In embodiments, the RPA system 624 may be embodied in the data processing and artificial intelligence system 410, or alternatively, the RPA system 624 and the data processing and artificial intelligence system 410 may be separate systems.

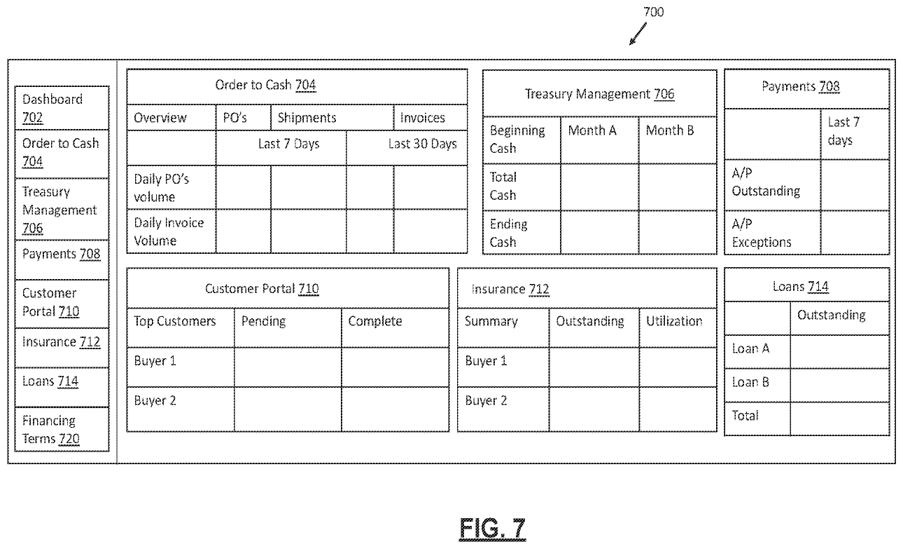

FIG. 7 depicts examples of the user interface 700 of the trade finance asset workflow and trading system 404, such as may be used to manage a set of business processes and workflows of one or more entities of the trade finance network 200. In embodiments, a dashboard 702 can provide an overview of all the different business processes and workflows including order to cash 704, treasury management 706, payments 708, customer portal 710, insurance 712 and loans 714. The dashboard 702 can also provide financing terms associated with the insurance 712, loans 714, and the like available through the dashboard 702. In embodiments, the order to cash 704 process manages processing of sales orders for goods and services and their payment. In these examples, the processes and workflows associated with the treasury management 706 can facilitate the cash flow process to calculate beginning cash, total cash and ending cash figures for a given month. The processes and workflows associated with the payments process 708 can facilitate, for example, an accounts payable process and provides an overview of all the outstanding, paid and held invoices. In embodiments, the customer portal 710 provides details about the various pending and complete purchase orders for the customers of a trade finance network entity like the seller bank. Similarly, the processes and workflows associated with the insurance 712 and loans 714 can provide and curate the details about the insurance policies and assets held by the entity that are involved in loans, sales or other trade finance activities including those provided in the financing terms 720.

In embodiments, digital trade assets may relate to trade credit insurance workflows. In contrast, trade credit insurance typically provides insurance for a party that is providing trade credit, assuring that parties are made whole to the extent of the coverage amount less any deductible in the case of a credit default. Trade credit insurers conventionally underwrite trade credit transactions primarily based on the overall credit worthiness of the parties involved, without visibility as to underlying details of the trade transaction. In many instances, insurers can be required to reserve capital in case of covered losses so in these examples, insurers may choose to wait until a transaction is fulfilled and reconciled (e.g., all goods are delivered and accepted, payments have been made, and loans have been repaid). While coverage should co-terminate upon the completion of the transaction (and the elimination of the covered risk), in fact insurers often wait from several days to several weeks before being notified by the buyer or another party of the completion. As a result, credit lines that could be used to insure additional transactions are unavailable, even though there is no actual risk being covered.

In embodiments, the platform 201 may facilitate the parties uploading digital trade assets (possibly in response to some set of incentives) including applicable trade credit insurance policies. By way of these example the artificial intelligence system 410 may, such with training by experts and optionally using RPA, learn to ingest and parse a trade credit insurance policy, such as to determine what elements of a trade finance transaction are covered by trade credit insurance, what elements are excluded, coverage amounts, deductibles, and the like. In embodiments, a digitized trade credit insurance policy may then be linked to other trade finance digital assets in the platform, such as to provide an insurer with notice when a trade transaction is complete (ending insurance), when covered events have occurred (such as a default by a party), and the like, as well as real-time reporting during the lifecycle of the trade finance asset and/or the lifecycle of insurance coverage. In these examples, other data in the platform 201 may assist insurers with underwriting and aggregate risk assessment, such as data indicating asset values, counterparty behavior, logistics workflows, pricing changes, and many others. In these examples, the other data in the platform 201 that may assist insurers with underwriting and aggregate risk assessment may be augmented by data from other systems, such as ERP systems, CRM systems, Insurance Policy Configurators, Insurance Document Management Systems and the like. One beneficial element is the reliable linking of a trade finance asset and the flow of money that relate to it. The asset may, for example, then be configured with a data model that causes it to represent its own state in a way that accounts for its position in a workflow, such that the asset's data object can be inspected to recognize its state with respect to the workflow (e.g., that the asset's workflows are pending certain steps, that workflows are completed, and the like). In embodiments, the asset may automatically notify appropriate parties of the need to take the next set of steps in a workflow, such as having the digital asset automatically notify the insurer when a final payment has been made, thereby closing out the transaction to which the asset relates.

In embodiments, the platform 201 may thus link, integrate and unify the following: a set of smart contracts that use markup languages or human-readable languages to embody legal contract terms (such as trade credit insurance terms, financing terms, and the like); a set of automated payment, fund transfer, and capital transfer workflows, such as enabled by banks and other financing sources; and a set of digital objects that represent entity and state information for digital assets for a trade, such as one that is the subject of a trade finance agreement.

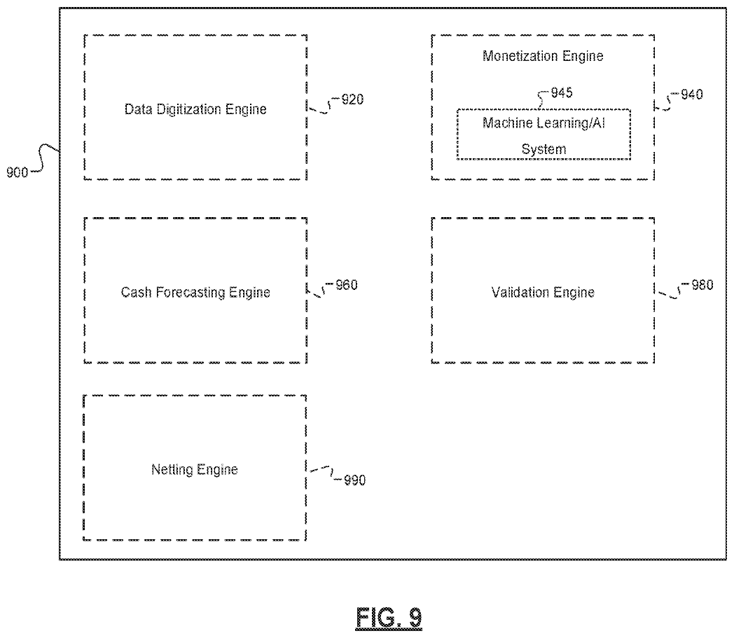

With reference to FIG. 9, in embodiments, the trade finance digital platform 201 can implement a trade finance asset digitization and tracking platform 900. The trade finance asset digitization and tracking platform 900 can include a data digitization engine 920 and a monetization engine 940. As described herein, e.g., with reference to FIGS. 5 and 8, the data digitization engine 920 can generate a set of trade finance digital objects 212 corresponding to a set of trade finance documents 112 of a user. Each of the set of trade finance documents 112 can comprise a record of a financial arrangement between the user and a second party based on a set of terms and conditions and each of the trade finance digital objects can comprise an electronic replication of data of its corresponding trade finance document that aligns with a trade finance data object model. In embodiments, the trade finance digital objects 212 can be structured as smart contracts to help automate workflows in the trade finance network 200. The monetization engine 940 can aggregate the trade finance digital objects 212 and assist a user of the platform with performing various tasks associated with monetizing the trade finance digital objects 212, such as the tasks described above (including, but not limited to, validating the sale of goods related to the invoice upon receiving the digital signatures or other form of confirmation of the transacting entities; initiating shipment of goods from the seller to the buyer upon receiving a digitally signed letter of credit; processing partial payment upon occurrence of a supply chain event corresponding to the physical movement of goods along the supply chain; processing partial payment upon delivery of goods to the buyer in accordance with the terms and conditions of the trade transaction; automatically submitting or processing an insurance claim upon non-payment of the invoice; automating application of a set of eligibility criteria to filter prospective counterparties for a set of trade finance agreements; automating a risk management workflow with respect to a set of trade finance transactions for a lender or insurer; automating workflows for insurance reporting; and handling of jurisdictional factors in a trade finance platform involving digitized trade finance asset; among others).

In embodiments, the monetization engine 940 can be configured to perform an automated process for determining a cost for monetizing trade finance digital objects 212, as further described herein. For example, a trade finance digital object 212 can correspond to an accounts receivable asset or other monetary item that is expected to be received by a user/business at a certain date (an expected receipt date). As mentioned herein, such trade finance documents 112 can comprise an accounts receivable item, an invoice, a purchase order, a bank guarantee, a letter of credit, an insurance certificate, a bank payment obligation, a letter of indemnity, and the like. In general, businesses may have the ability to access the capital associated with such an accounts receivable asset in advance of the expected receipt date, e.g., via selling of the accounts receivable asset or other monetary asset (factoring), invoice discounting, or other similar process. There are, however, costs associated with such a process. Such costs can be dependent on many factors, including but not limited to the time period until the expected receipt data, and the parties involved (and their relative credit-worthiness). The monetization engine 940 can include an artificial intelligence/machine learning system to generate pricing for the trade finance digital object 212 in order to estimate/determine an expected cost for accessing the value of each trade finance digital object 212. In this manner, the monetization engine 940 can provide a user with the lowest cost options for accessing the value of trade finance digital object(s) 212.

In embodiments, the monetization engine 940 can determine a value for each trade finance digital object 212 based on the electronic replication of the data of its corresponding trade finance document 112. Further, the monetization engine 940 can determine a cost to access the value for each trade finance digital object at a particular time. Finally, the monetization engine 940 in conjunction with the trade finance asset digitization and tracking platform 900 can permit the user to transfer ownership of one or more of the trade finance digital objects 212 to another party. In embodiments, and as more fully described herein, the monetization engine 940 can coordinate the transfer of ownership of one or more of the trade finance digital objects 212 to another party.

As mentioned above, in order to determine a cost to access the value for each trade finance digital object 212 at a particular time, the monetization engine 940 can implement an artificial intelligence/machine learning system 945 to generate pricing for the trade finance digital object 212 in order to estimate/determine an expected cost for accessing the value of each trade finance digital object 212. The artificial intelligence/machine learning system 945 can be a model that is trained via supervised, semi-supervised, unsupervised learning, or other training process. The artificial intelligence/machine learning system 945 can determine the cost based on various features of the trade finance digital object 212, such as the time period until the expected receipt date (financing period), the parties involved (and their relative credit-worthiness), expected sources of the financing (the funding options or the parties that may provide financing for a particular trade finance digital object 212), the set of terms and conditions of the financial arrangements captured by the trade finance digital object 212, likely pricing from potential financiers/purchasers/insurers of the trade finance digital object 212, as well as historical data and/or market data associated with each of the above features. In embodiments, the monetization engine 940 can determine the cost to access the value for each trade finance digital object 212 at the particular time for each of the plurality of funding options based on one or more of: historical pricing of a particular funding option, a time period between the particular time and a maturation date (expected receipt date) of each trade finance digital object 212, an identity of the party from whom the payment is expected, a currency exchange rate, a jurisdiction associated with each trade finance digital object, a credit rating (of the user and/or the party from whom the payment is expected).

The monetization engine 940 can be configured to output a ranked list of the set of trade finance digital objects 212 based on the costs to access the value for each trade finance digital object 212 at the particular time. For example, the ranked list can be output on a graphical user interface associated with a computing device (e.g., a user computing device), and the ranked list can be automatically updated by the monetization engine 940 (dynamically, in real-time, etc.) as the ranked list changes. In this manner, a user of the trade finance digital platform 201 can be provided with various options for accessing the value of one or more of its trade finance digital objects 212 at a particular time, ranked by cost, such that the user can easily view and ascertain the lowest cost option.

With continuing reference to FIG. 9, in embodiments, the trade finance asset digitization and tracking platform 900 can alternatively or additionally include a cash forecasting engine 960. The cash forecasting engine 960 can aggregate the trade finance digital objects 212 and assist a user of the platform with determining cash forecasting based on the expected intake and outlay of funds associated with the trade finance digital objects 212. For example only, the cash forecasting engine 960 can be configured to perform an automated process for determining a forecast for the liquidity position of a user based on the trade finance digital objects 212, as further described herein.

As mentioned, a trade finance digital object 212 can correspond to an accounts receivable asset, an accounts payable asset, or other monetary item that is expected to be received/paid by a user/business at a certain date (an expected receipt/payment date). Such trade finance documents 112 can comprise an accounts receivable item, an invoice, a purchase order, a bank guarantee, a letter of credit, an insurance certificate, a bank payment obligation, a letter of indemnity, and the like. In general, businesses look to maintain an adequate liquidity position by forecasting cash flows, both in and out. Due to the number and nature of the trade finance digital objects 212, it can be difficult to ascertain the expected receipt/payment dates for the various cash flows of a user. Further, the other party associated with a trade finance digital object 212 such as an invoice to be paid to the user may not pay in full, or by the expected payment date, or may otherwise deviate from the terms of the trade finance digital object 212. Accordingly, a typical cash forecasting process must be performed manually and may not provide a level of accuracy that is desired for the user.

In embodiments, the cash forecasting engine 960 can determine a liquidity position for the user based on the electronic replication of data of the trade finance documents 112 corresponding to the trade finance digital objects 212. The cash forecasting engine 960 can be integrated into, receive data/communications from, or otherwise interact with the trade finance digital platform 201 and other components thereof. For example only, the cash forecasting engine 960 can receive data/information related to accounts payable information of the user, to intracompany flow of capital of the user, and like from the trade finance digital platform 201 and utilize such information to forecast the cash position of the user.

In embodiments, the cash forecasting engine 960 can include an artificial intelligence/machine learning system or model to forecast a cash position of the user at a future date. The machine learning model is trained to detect patterns associated with each of the trade finance digital objects 212 based on historical payment activity of its corresponding party. For example only, the machine learning model can be trained to detect a payment delay pattern comprising a time difference between a contracted payment date and an actual payment date from a particular party. Alternatively or additionally, the machine learning model can be trained to detect a specific day of week pattern comprising a consistent day of week associated with payments from a particular party. In yet another example, the machine learning model can be trained to detect a time period of month pattern comprising a consistent time period of month (beginning of the month, a middle of the month, or an end of the month) associated with payments from a particular party. In this manner, the cash forecasting engine 960 can provide a user with a more accurate cash forecast based at least partially on the trade finance digital object(s) 212.

In embodiments, machine learning model can be configured to determine a confidence score of the forecasted cash position of the user at the future date. For example only, the output of the cash forecasting engine 960 can include not only a forecasted cash position, but also a measurement of the confidence level of that forecast. In embodiments, the confidence score can be compared to a threshold such that, when the confidence score satisfies the threshold, the cash forecast can be relied upon by the user. When the confidence score does not satisfy the threshold, cash forecasting engine 960 can output a notification to the user that the cash forecast may not satisfy the desired accuracy level of the user.

In embodiments, the trade finance asset digitization and tracking platform 900 can include a validation engine 980 that is used to update the machine learning model associated with the cash forecasting engine 960. In aspects, the validation engine 980 can update the historical payment activity upon which the machine learning model is trained upon various events. For example only, the validation engine 980 can compare one or more cash position forecasts for a certain date with the actual cash position at that certain date to determine if the cash forecasting engine 960 is performing satisfactorily. In the event that the cash forecasting engine 960 is not performing satisfactorily, the validation engine 980 can update the machine learning model of the cash forecasting engine 960. Other techniques for updating the machine learning model of the cash forecasting engine 960 are contemplated.

In embodiments, the trade finance asset digitization and tracking platform 900 can include a netting engine 990 for balancing cash flows between two parties. For example only, the netting engine 990 can be configured to detect an expected payment from a particular party to a user, and an expected payment to the particular party from the user. In such a situation, the netting engine 990 can output a notification to the user and the particular party when there is both the expected payment from and the expected payment to the particular party and the trade finance asset digitization and tracking platform 900 can assist in the payment workflow. In an example, upon detection a user's the expected payment from and an expected payment to the particular party, the netting engine 990 (e.g., in conjunction with the other components of the trade finance asset digitization and tracking platform 900) can automatically satisfy one or both of the expected payment from and the expected payment to the particular party. In this manner, the trade finance asset digitization and tracking platform 900 can reduce the number of financial transactions between users, which may reduce the cost of such transfers (bank fees, etc.).

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, an IoT device, cloud server, serverless cloud platform, client, network infrastructure, mobile computing platform, stationary computing platform, container, serverless container or other computing platforms. A processor may be any kind of computational or processing device (cloud, on-prem or IoT/mobile) capable of executing program instructions, codes, binary instructions and the like, including a central processing unit (CPU), a graphic processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through a machine that executes computer software on a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, IoT devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), container as a service (CaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured object-oriented, compiled programming language such as C# or C++, or any other high-level (Javascript, Python, Go, Typescript, Angular, React, or the like) or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions. Computer software may employ virtualization, virtual machines, containers, and other capabilities.

Thus, in one aspect, methods described above and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and ‘the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure. All documents referenced herein are hereby incorporated by reference as if fully set forth herein.

We claim:

1. A computer-implemented method comprising:
ingesting, by the at least one processor of the digital asset generation platform, an ingest input that comprises a plurality of digital files in a plurality of digital formats, wherein the plurality of digital files comprises at least one digital representation of at least one document;
utilizing, by the at least one processor of the digital asset generation platform, a digitization engine to automatically extract a plurality of data elements from each digital file of the ingest input,
wherein the digitization engine comprises a natural language processing model to extract the plurality of data elements from each digital file of the ingest input,
wherein the automatically converted plurality of digital elements from each digital file of the ingest input is at least one digital asset of a plurality of digital assets,
wherein the plurality of data elements of each digital file comprise at least one data object model of a plurality of data object models;
determining, by the at least one processor of the digital asset generation platform, a policy that is associated with the ingest input;
wherein the policy comprises at least one term controlling the ingest input;
generating, by the at least one processor of the digital asset generation platform, a plurality of data processing engines associated with each data object model,
wherein each data processing engine has at least one programming instruction to execute a visual processing of a plurality of artifacts associated with each data object model;
automatically determining, by the at least one processor of the digital asset generation platform, a relationship between at least two related data elements of the plurality of data elements associated with each data object model,
utilizing, by the at least one processor of the digital asset generation platform, a machine learning algorithm to calculate an overall confidence score for each data object model of the plurality object models;
validating, by the at least one processor of the digital asset generation platform, each data object model of the plurality of data object models based on the calculated overall confidence score for each data object model of the plurality of data object models;
generating, by the at least one processor of the digital asset generation platform, a plurality of workflows associated with the plurality of data object models by processing the plurality of data processing engines associated with each data object model based on the relationship between the at least two different data object models;
utilizing, by the at least one processor of the digital asset generation platform, at least one generated workflow of the plurality of generated workflows associated with the plurality of data object models to performs at least one ameliorative action; and
automatically updating, by the at least one processor of the digital asset generation platform, the plurality of generated workflows associated with the plurality of data object models at predetermined periods of time.

2. The computer-implemented method of claim 1, further comprising instructing, by the at least one processor of a digital asset generation platform, a computing device associated with a user to display the plurality of generated workflows on a graphical user interface within the computing device.

3. The computer-implemented method of claim 2, wherein the digital asset generation graphical user interface comprises a plurality of graphical user elements that are configured to allow the user to identify the ingest input that comprises the plurality of digital files in the plurality of digital formats.

4. The computer-implemented method of claim 1, wherein the plurality of digital files comprises at least one digital representation of at least one physical document.

5. The computer-implemented method of claim 1, further comprising detecting, by the at least one processor of the digital asset generation platform, at least one duplicate digital asset based on an analysis of a plurality of supporting documents based on the calculated overall confidence score associated with each data object model of the plurality of data object models.

6. The computer-implemented method of claim 5, further comprising automatically deleting, by the at least one processor of the digital asset generation platform, the at least one detected duplicate digital asset based on the at least one digital asset.

7. The computer-implemented method of claim 1, wherein the calculated overall confidence score for each data object model of the plurality object models validates a plurality of delivery factors.

8. The computer-implemented method of claim 7, wherein the plurality of delivery factors comprises one or more acceptable participants, one or more modes of transport, and one or more delivery parameters for a network.

9. The computer-implemented method of claim 1, wherein the generated workflow is stored in a server computing device.

10. A computing-implemented method comprising:
ingesting, by the at least one processor of the digital asset generation platform, an ingest input that comprises a plurality of digital files in a plurality of digital formats, wherein the plurality of digital files comprises at least one digital representation of at least one physical document;
utilizing, by the at least one processor of the digital asset generation platform, a digitization engine to automatically extract a plurality of data elements from each digital file of the ingest input,
wherein the digitization engine comprises a natural language processing model to extract the plurality of data elements from each digital file of the ingest input,
wherein the automatically converted plurality of digital elements from each digital file of the ingest input is at least one digital asset of a plurality of digital assets, wherein the plurality of data elements of each digital file comprise at least one data object model of a plurality of data object models;
determining, by the at least one processor of the digital asset generation platform, a policy that is associated with the ingest input;
wherein the policy comprises at least one term controlling the ingest input;
generating, by the at least one processor of the digital asset generation platform, a plurality of smart contracts associated with each data object model,
wherein each smart contract of the plurality of contracts has at least one programming instruction to execute the at least one term of the policy;
automatically mapping, by the at least one processor of the digital asset generation platform, at least two related data elements of the plurality of data elements associated with each data object model,
wherein the at least two related data elements of the plurality of data elements are from at least two different data object models of the plurality of data object models;
linking, by the at least one processor of the digital asset generation platform, at least two different data object models of the plurality of data object models based on the at least two related data elements of the plurality of data elements;
utilizing, by the at least one processor of the digital asset generation platform, a machine learning algorithm to calculate an overall confidence score for each data object model of the plurality object models;
validating, by the at least one processor of the digital asset generation platform, each data object model of the plurality of data object models based on the calculated overall confidence score for each data object model of the plurality of data object models;
generating, by the at least one processor of the digital asset generation platform, a plurality of workflows associated with the plurality of data object models by compiling the plurality of smart contracts associated with each data object model based on the at least two different data object models being linked;
utilizing, by the at least one processor of the digital asset generation platform, at least one generated workflow of the plurality of generated workflows associated with the plurality of data object models to performs at least one ameliorative action;
automatically updating, by the at least one processor of the digital asset generation platform, the plurality of generated workflows associated with the plurality of data object models at predetermined periods of time; and
instructing, by the at least one processor of a digital asset generation platform, a computing device associated with a user to display the plurality of generated workflows associated with the plurality of data object models on a graphical user interface within the computing device, wherein the digital asset generation graphical user interface comprises a plurality of graphical user elements that are configured to allow the user to identify the ingest input that comprises the plurality of digital files in the plurality of digital formats.

11. The computer-implemented method of claim 10, wherein the plurality of digital files comprises at least one digital representation of at least one physical document.

12. The computer-implemented method of claim 10, further comprising detecting, by the at least one processor of the digital asset generation platform, at least one duplicate digital asset based on an analysis of a plurality of supporting documents based on the calculated overall confidence score associated with each data object model of the plurality of data object models.

13. The computer-implemented method of claim 12, further comprising automatically deleting, by the at least one processor of the digital asset generation platform, the at least one detected duplicate digital asset based on the at least one digital asset.

14. The computer-implemented method of claim 10, wherein the calculated overall confidence score for each data object model of the plurality object models validates a plurality of delivery factors.

15. The computer-implemented method of claim 14, wherein the plurality of delivery factors comprises one or more acceptable participants, one or more modes of transport, and one or more delivery parameters for a network.

16. The computer-implemented method of claim 10, wherein the generated workflow is stored in a server computing device.

17. A system comprising:
a non-transient computer memory, storing software instructions;
at least one processor of a first computing device associated with a user;
wherein, when the at least one processor executes the software instructions, the first calling-enabled computing device is programmed to:
ingesting, by the at least one processor of the digital asset generation platform, an ingest input that comprises a plurality of digital files in a plurality of digital formats, wherein the plurality of digital files comprises at least one digital representation of at least one physical document;
utilizing, by the at least one processor of the digital asset generation platform, a digitization engine to automatically extract a plurality of data elements from each digital file of the ingest input,
wherein the digitization engine comprises a natural language processing model to extract the plurality of data elements from each digital file of the ingest input,
wherein the automatically converted plurality of digital elements from each digital file of the ingest input is at least one digital asset of a plurality of digital assets, wherein the plurality of data elements of each digital file comprise at least one data object model of a plurality of data object models;
determining, by the at least one processor of the digital asset generation platform, a policy that is associated with the ingest input;
wherein the policy comprises at least one term controlling the ingest input;
generating, by the at least one processor of the digital asset generation platform, a plurality of smart contracts associated with each data object model,
wherein each smart contract of the plurality of contracts has at least one programming instruction to execute the at least one term of the policy;
automatically mapping, by the at least one processor of the digital asset generation platform, at least two related data elements of the plurality of data elements associated with each data object model,
wherein the at least two related data elements of the plurality of data elements are from at least two different data object models of the plurality of data object models;
linking, by the at least one processor of the digital asset generation platform, at least two different data object models of the plurality of data object models based on the at least two related data elements of the plurality of data elements;
utilizing, by the at least one processor of the digital asset generation platform, a machine learning algorithm to calculate an overall confidence score for each data object model of the plurality object models;
validating, by the at least one processor of the digital asset generation platform, each data object model of the plurality of data object models based on the calculated overall confidence score for each data object model of the plurality of data object models;
generating, by the at least one processor of the digital asset generation platform, a plurality of workflows associated with the plurality of data object models by compiling the plurality of smart contracts associated with each data object model based on the at least two different data object models being linked;
utilizing, by the at least one processor of the digital asset generation platform, at least one generated workflow of the plurality of generated workflows associated with the plurality of data object models to performs at least one ameliorative action; and
automatically updating, by the at least one processor of the digital asset generation platform, the plurality of generated workflows associated with the plurality of data object models at predetermined periods of time.

18. The system of claim 17, further comprising instructing, by the at least one processor of a digital asset generation platform, a computing device associated with a user to display the plurality of generated workflows on a graphical user interface within the computing device.

19. The system of claim 17, wherein the plurality of digital files comprises at least one digital representation of at least one physical document.

20. The system of claim 17, wherein the calculated overall confidence score for each data object model of the plurality object models validates a plurality of delivery factors.
